(19) United States
(12) Patent Application Publication
(10) Pub. No.: US 2026/0276569 A1
(43) Pub. Date: Sep. 17, 2026

(54) METHOD AND APPARATUS FOR DICTIONARY LEARNING AND FOR RECONSTRUCTING IMAGES USING A DICTIONARY

(71) Applicant: THE UNIVERSITY OF LIVERPOOL, Liverpool (GB)

(72) Inventors: Nigel BROWNING, Liverpool (GB); Jony CASTAGNA, Warrington Cheshire (GB); Daniel NICHOLLS, Liverpool (GB); Alex ROBINSON, Liverpool (GB); Jack WELLS, Liverpool (GB); Yalin ZHENG, Liverpool (GB)

(21) Appl. No.: 19/168,558

(22) PCT Filed: Mar. 26, 2024
(86) PCT No.: PCT/GB2024/050814

§ 371 Date: Sep. 24, 2025

(30) Foreign Application Priority Data
Mar. 27, 2023 (GB) 2304469.6

(51) Int. Cl. G01N 23/2251; G06V 10/40

(52) U.S. Cl. CPC G01N 23/2251; G06V 10/513; G01N 2223/306; G01N 2223/418

(57) ABSTRACT

We describe a method of providing a dictionary by sparse dictionary learning of N-dimensional image data, wherein N is a natural number greater than or equal to 3 and the method is implemented by a computer comprising a processor and a memory. The method comprises defining an N-dimensional patch for the N-dimensional image data; extracting N_{batch} data sub-regions from the N-dimensional image data, using the defined N-dimensional patch; and providing the dictionary by dictionary learning using the extracted N_{batch} data sub-regions. We also describe a method of reconstructing images from sparse N-dimensional image data using such a dictionary.

### FIELD

The present invention relates to dictionary learning of images, for example electron microscopy images and to reconstructing images using dictionaries.

### BACKGROUND TO THE INVENTION

Over the last few years, methods in Dictionary Learning and/or Image Inpainting have been successfully applied to many different forms of Electron Microscopy (EM) data. In the context of these methods, a dictionary of atoms can be used to sparsely represent each overlapping patch as a linear combination of a small number of dictionary elements and their corresponding coefficients. The choice of dictionary atoms can be learned from fully-sampled data using traditional techniques such as K-SVD or directly from subsampled data using Bayesian methods such as Beta-Process Factor Analysis (BPFA), and the resulting sparse representations can be used for tasks such as compression, inpainting, denoising, and image classification. Typically, this target “image” data would be 2-dimensional (2D), such as Z-contrast images from a Scanning Transmission Electron Microscope (STEM), or in some cases 3-dimensional (3D), such as RGB images, successive 2D layers of a 3D volume e.g. cryo-FIB, or Energy-Dispersive X-ray spectroscopy (EDS) maps which use the third dimension for discretised spectral information. In most historical approaches, for an “image” of shape M=(M₀, M₁, M₂), the dictionaries used represent a set of (vectorised) elements with a patch shape B defined only in the first two dimensions—that is, patches with a height (B₀<<M₀) and width (B₁<<M₁), where the size of the patch in the third dimension spans the entire shape of the target data cube (B₂=M₂). For the simple cases of 2D/Greyscale images (M₂=1) and RGB images (M₂=3), this is a relatively straightforward approach; in fact, in many cases, the patch shape B is defined by a single integer value b (b=B₀=B₁) such as b=10, where patches take the shape of B=(10,10, M₂).

However, there remains a need to improve dictionary learning of image data and/or reconstruction of sparse image data.

### SUMMARY OF THE INVENTION

It is one aim of the present invention, amongst others, to provide a method of providing a dictionary by sparse dictionary learning of N-dimensional image data which at least partially obviates or mitigates at least some of the disadvantages of the prior art, whether identified herein or elsewhere.

A first aspect provides a method of providing a dictionary by sparse dictionary learning of N-dimensional image data, wherein N is a natural number greater than or equal to 3, the method implemented by a computer comprising a processor and a memory, the method comprising: defining an N-dimensional patch for the N-dimensional image data;
extracting N_{batch} data sub-regions from the N-dimensional image data, using the defined N-dimensional patch; and
providing the dictionary by dictionary learning using the extracted N_{batch} data sub-regions.

A second aspect provides a method of reconstructing images from sparse N-dimensional image data, wherein N is a natural number greater than or equal to 3, the method implemented by a computer comprising a processor and a memory, the method comprising:
reconstructing an image from the sparse N-dimensional image data using a dictionary, for example wherein the dictionary is provided according to the first aspect.

A third aspect provides a method of controlling an electron microscope, the method implemented, at least in part, by a computer comprising a processor and a memory, the method comprising:
providing parameters of the electron microscopy;
obtaining first sparse N-dimensional electron microscopy data of a sample, wherein N is a natural number greater than or equal to 3; and
reconstructing a first electron microscopy image of the sample from the first sparse N-dimensional electron microscopy data, according to the second aspect.

A fourth aspect provides a computer comprising a processor and a memory configured to implement a method according to any of the first aspect, the second aspect and/or the third aspect, a computer program comprising instructions which, when executed by a computer comprising a processor and a memory, cause the computer to perform a method according to any of the first aspect, the second aspect and/or the third aspect or a non-transient computer-readable storage medium comprising instructions which, when executed by a computer comprising a processor and a memory, cause the computer to perform a method according to any of the first aspect, the second aspect and/or the third aspect.

A fifth aspect provides an electron microscope including a computer comprising a processor and a memory configured to implement a method according to any of the first aspect, the second aspect and/or the third aspect.

### DETAILED DESCRIPTION OF THE INVENTION

According to the present invention there is provided a method of providing a dictionary by sparse dictionary learning of N-dimensional image data, as set forth in the appended claims. Also provided is a method of reconstructing an image, a method of controlling an electron microscope, a computer, a computer program, a non-transient computer-readable storage medium, an electron microscope and use of a pre-learned dictionary. Other features of the invention will be apparent from the dependent claims, and the description that follows.

### Providing a Dictionary

The first aspect provides a method of providing a dictionary by sparse dictionary learning of N-dimensional image data, wherein N is a natural number greater than or equal to 3, the method implemented by a computer comprising a processor and a memory, the method comprising: defining an N-dimensional patch for the N-dimensional image data;
extracting N_{batch} data sub-regions from the N-dimensional image data, using the defined N-dimensional patch; and
providing the dictionary by dictionary learning using the extracted N_{batch} data sub-regions.

In contrast to the 2D and 3D examples described in the Background, there are many examples of higher-dimensional EM data, and more complex tasks such as real-time (frame-by-frame) reconstructions (see Table 1) that would benefit from variable patch shapes in higher dimensions. For the case of multi-frame targets such as greyscale and RGB video, this could represent dictionary elements trained with a higher-dimensional patch shape spanning a few (or more) frames of the video, i.e. capturing representative signal patterns for the change in pixel values with respect to time in addition to the spatial dimensions, or conversely, training/inpainting with a single-channel dictionary for 2D patches across each layer of a multi-channel (e.g. RGB) data source. For hyperspectral data cubes, it may represent the generation/use of a dictionary spanning an arbitrary n “steps” (n<<M_2) across a discretised spectrum, or a method of frame-interpolation for data cubes subsampled in the fourth (time) dimension. This much more varied patch shape also allows for further, more complex scenarios, such as dictionary transfer between a 2D high-SNR source such as a Back-Scattered Electron (BSE) image and the low-SNR constituent “layers” of a 3D EDS map, improving the quality of reconstruction results as well as reducing the complexity (and thus time-to-solution) of the dictionary learning/inpainting task. The extension of dictionary learning and/or image inpainting algorithms into this N-dimensional context, especially with the goal of performing on batches of N_{batch} arbitrarily indexed (e.g. programmatically selected) patches/signals from the target data cube necessitates the development of efficient implementations of signal extraction as well as reconstruction/recombination (beyond the capabilities of standard “unwrap”/“wrap” methods respectively in most computational libraries). However, with a sufficiently optimised implementation, it can provide a significant improvement to the speed of real-time reconstructions on large datasets, a boost to reconstruction quality for low-SNR data, and may even enable completely new uses of a trained dictionary, such as dictionary transfer between “layers”, frame-interpolation, and a combination of detector and/or probe subsampling for 4D-STEM/Ptychography.

The examples described herein relate to the development of software and methods for enabling real-time ‘live’ subsampled image (or video frame) reconstruction via Bayesian dictionary learning, aimed at use in commercial Electron Microscopy applications. The potential application of this invention includes any raster-scan imaging system, such as an Electron Microscope, for which scanning time is significant; by drastically reducing the quantity of measurements (and thus time) needed for the formation of a complete image.

While exemplary methods according to the first aspect described herein generally relate to electron microscopy images of samples, more generally, the method may be applied to any N-dimensional image data, such as images of samples acquired using other analytical techniques. Hence, for example, the first aspect provides a method of providing a dictionary by sparse dictionary learning of N-dimensional image data of a first sample due to interaction of electromagnetic radiation and/or particles with the sample. It should be understood that the steps of the method according to the first aspect are implemented mutatis mutandis. In other words, while the method according to the first aspect may relate to electron microscopy images of samples, the method may be applied mutatis mutandis to other image methods, for example for optical and X-ray techniques as well as images of basic physical properties such as band structure. Hence, more generally, the first aspect provides a method of providing a dictionary by sparse dictionary learning of N-dimensional image data comprising physical properties of a chemical, material and/or biological system and images produced of those systems by interaction with light, X-rays, protons, neutrons and/or electrons or by any other means.

Advantageously, the methods and apparatuses described herein may provide one or more of:
An efficient software implementation of an online (mini-batch) Bayesian dictionary learning algorithm requiring only subsampled data as its input, applicable to both CPU and GPU operation.
A novel method for efficient and adaptive sampling of image sub-regions (patches) and rearrangement into a memory-efficient form appropriate for use in dictionary learning and/or reconstruction algorithms, capable of being performed on-demand on both CPU's and GPU's.
A novel reconstruction method for displaying a ‘live’ (pre-) view of the reconstructed image throughout the reconstruction process.
Additional abilities in reconstruction (due to the new method of operating on an image)—strategic and/or adaptive sampling, multiple simultaneous dictionaries of different sizes, separation of algorithmic workload across multiple processor nodes (CPU's and/or GPU's).
Additionally: An approach to dictionary specialisation/generation e.g. use of simulated STEM images for dictionary generation, previous master dictionary approaches, highly-sampled initial frames (with higher damage) used to impaint further much more subsampled frames (with minimal damage) i.e. a form of burn-in for the dictionary learning algorithm as avenues to increase/retain reconstruction quality alongside the above optimisation methods.

Compared with conventional approaches, the methods and apparatuses described herein may provide one or more of:
Subsampled/‘Blind’ Bayesian Dictionary learning provides a method of generating an optimal dictionary for the given application, producing better quality reconstructions than off-the-shelf transform dictionaries, wavelets and other previous methods.
A more efficient online implementation of this Dictionary Learning algorithm reduces the time-to-solution down from hours to seconds/minutes (CPU), enabling its practical application in the field of compressive sensing electron microscopy.
A novel method for memory-efficient and on-demand signal batch generation (i.e. programmable access to any set of image sub-regions) allows for many new concepts in dictionary learning and image reconstruction to be implemented; such as ‘live’ reconstructions, adaptive/strategic sampling of the target image (depending on the results of the previous iteration) and multiple dictionary learning algorithms (using dictionaries/sub-regions with different patch sizes) operating simultaneously on the same image.
“Strategic” Sampling (when combined with a “subject detection” method e.g. particle detection) allows for the most important sub-regions of an image (where the “subject” is detected as present) to be reconstructed with higher frequency/priority/computational time.
“Adaptive” Sampling (when combined with a reasonable quality metric) allows for the most poorly reconstructed (or in other approaches, the most well reconstructed) regions of an image to receive a higher priority on each subsequent frame.
Multiple dictionaries (with potentially/likely different sub-region/patch sizes) operating simultaneously (especially when combined with the above) allows for different feature sizes, attributes etc within an image to be reconstructed in parallel; for STEM, this may be different parts of the same material in an image at different focus conditions, orientations, or depths within the sample-improving reconstruction quality. (OR, using the same patch sizes, this is a potential method of implementing split dictionary learning such as high and low frequency features mentioned in the last patent).
A continuous ‘live’ view of the learned dictionary provides insight into the success of the algorithm as well as a way of optimising hyperparameters for producing the best quality reconstruction.
A novel method of generating a continuously updating preview of the reconstructed image provides a means of performing even faster reconstructions by terminating the algorithm early once an acceptable reconstruction quality has been reached. Previous approaches typically require a full completion on an ‘epoch’ before any results may be displayed.
An even more efficient software implementation on a GPU using the same techniques enables even faster iterations (milliseconds) for real-time ‘live’ STEM video reconstruction.

### Method

The first aspect provides the method of providing a dictionary by sparse dictionary learning of N-dimensional image data, wherein N is a natural number greater than or equal to 3, the method implemented by a computer comprising a processor and a memory, the method comprising: defining an N-dimensional patch for the N-dimensional image data;
extracting N_{batch} data sub-regions from the N-dimensional image data, using the defined N-dimensional patch; and providing the dictionary by dictionary learning using the extracted N_{batch} data sub-regions.

In one example, N is greater than or equal to 2 (i.e. less than 3). In one example, N=3. In one preferred example, N=4. In one example, N>4, for example wherein N=5, 6, 7, 8, 9, 10, 11, 12 or more.

### Dictionary

The method comprises providing the dictionary by dictionary learning using the extracted N_{batch} data sub-regions.

A dictionary of atoms can be used to sparsely represent image patches by representing each overlapping patch as a linear combination of a small number of dictionary elements and their corresponding coefficients. This allows for efficient representation and compression of image data. The choice of dictionary atoms can be learned from the data using techniques such as dictionary learning, and the resulting sparse representations can be used for tasks such as denoising, compression, and image classification.

A typical form of dictionary representation (an underdetermined linear equation system) is shown in FIG. 1, where y represents a column matrix of target signals (image sub-regions), D represents the dictionary of elements, and a represents a matrix of coefficients (or sparse encodings for the dictionary of signals).

In one example, an algorithm for dictionary-learning is BPFA (Beta-Process Factor Analysis). Other algorithms are known. BPFA may be used for subsampled image reconstruction by exploiting the sparsity of natural images in a learned dictionary of elements. Given a set of subsampled image patches, BPFA may estimate a set of latent variables that capture the underlying structure of the data, including the sparse coefficients corresponding to the dictionary elements. By leveraging a Bayesian framework, BPFA can infer the most likely set of sparse coefficients that explain the observed data, while also accounting for noise and model complexity.

### Reshaping

In one example, the method comprises reshaping the N-dimensional image data. For example, a 2D signal may be reshaped into a 1D column vector by appending all sequential columns (or rows). This process can be extended into 3D, 4D and higher dimensions, thereby providing a method of transforming higher-dimensional data into a column vector (the format necessary for dictionary learning and sparse-coding) and a reverse method of returning to the higher-dimensional shape.

### Extracting Patches

The method comprises extracting N_{batch} data sub-regions from the N-dimensional image data, using the defined N-dimensional patch.

Conventionally, in order to perform methods such as dictionary learning and sparse-coding on sub-regions of an image, a process of “unwrapping” the data would be involved, a method of generating the entire Y matrix with a column for each and every possible overlapping sub-region of the “image” (or perhaps some crop of it).

In the case of many libraries, such as Arrayfire (GPU Matrix Library in C++), this defaults to non-overlapping patches, but is easily changed by altering the stride value (in this case, sx and sy). The result for all of these libraries (C++, Python, Matlab etc) is essentially a very “fat” matrix Y with all of the sub-regions possible in the convolution. If subsets of this full Y matrix are needed for batch operations, they are then extracted or accessed from this full Matrix stored in memory.

While the method of achieving this is a convolution, and so has many efficient implementations, it quickly becomes very costly in terms of memory usage (for large M, such as 4K+ images or hyperspectral data with a large number of channels), but also requires a significant amount of time in computation, especially if expected to be performed in real-time (such as in the case of live/frame-by-frame reconstruction of a high-framerate, evolving input (with time). In many cases, the full Y matrix is therefore not necessary to compute, such as in the intended case of dictionary learning/sparse coding algorithms like BPFA which only operate on N_{batch}<<Nₜₒₜₐₗ overlapping subregions per iteration (i.e. at a given time).

To perform dictionary learning rapidly on many (often thousands) of arbitrary (programmatically selected) sub-regions of an image, we must first index all possible patches (or sub-regions) and then determine an efficient method of signal/pixel extraction (using any given set of patch indices) from a potentially variable input source in order to form the necessary columns of the signal matrix Y for a given batch. Each column of this matrix represents a vectorised sub-region of an image to be used in the current dictionary-learning and/or sparse-coding batch/operation.

In the following notation (going forward) Mᵢ, Bᵢ etc. will refer to the length of the shape in the i^{th} dimension, and mᵢ, bᵢ etc. will refer to the last zero-based index in that dimension.

### 2D Example

Consider a (2D) arrangement of pixel data for an image of shape M=(M₀, M₁) and a patch shape B=(B₀, B₁).

There will be a total of (M₀−B₀+1)×(M₁−B₁+1) patches.

The patches may be indexed by the (in this case 2D) coordinates of the first contained/origin pixel, or reduced further to a linear index Pₗᵢₙₑₐᵣ for indexing in system memory. All that is needed to convert between a linear index and coordinates is the total dimensions of the pixel data, and the shape of the patch/sub-region.

For patch index P (p₀, p₁), the linear index Pₗᵢₙₑₐᵣ=(M₀−B₀+1)×p₁+p₀ (ordering Column-Major).

Denoting the patch index coordinates as P (p₀, p₁), indexes (in 2D) therefore range between:

$$0 \geq {p}_{0} \leq ( {M}_{0} - {B}_{0} + 1 ) and 0 \geq {p}_{1} \leq ( {M}_{1} - {B}_{1} + 1 )$$

$$0 \geq {P}_{linear} \leq ( {M}_{0} - {B}_{0} + 1 ) \times ( {M}_{1} - {B}_{1} + 1 )$$

This can be generalised to i dimension, where the index P of any single possible subregion will lie within the range 0≥pᵢ≤Mᵢ−Bᵢ+1. The set of all combinations of these valid indices in each of the i dimensions form the total set of possible data sub-regions. Each patch index P may also be converted to a pixel index within the full data shape M by using the known data stride of the source data “cube” in memory.

### 3D Example

Consider a 3D arrangement of pixel data for an “image: of shape M=(M₀, M₁, M₂) and a patch shape B=(B₀, B₁, B₂).

The term “image” here is vague as this third dimension could take multiple forms. Perhaps most typically, m₂ can be considered the number of channels an image has, in the case of:
Greyscale Images/Video (m₂=1 channel)
RGB Images/Video (m₂=3 channels).
Hyperspectral Image/Video (m₂=n_{channels})

But this could be something else entirely, from (m₂=nᵥₐₗᵤₑₛ) different colour space conversions e.g. CMYK, or indexing of diffraction patterns in 4D-STEM.

For Greyscale, RGB Image and RGB Video, for example, it often (though not always) makes sense to work with a dictionary with a vectorized column length equal to a patch of shape B where (B₂=M₂), i.e. use a patch shape equal to the total number of channels (such as extracting overlapping RGB patches from an image/video to work with an RGB dictionary). In most typical implementations of DL/sparse-coding, BPFA, OMP etc., this is what is performed (usually by-default due to the use of an unwrapping method (as described above) which is often limited to this behaviour.

However, this will not always be the optimal case, such as for Hyperspectral Image/Video, or any of the other uses of this dimension where you will (very likely) want to capture dictionary elements significantly smaller than the total (B₂<<M₂) that traverse the channel dimension in the same way a 2D window traverses the image (as B₀<<M₀ and B₁<<M₁). Therefore, for generalising the implementation, we can assume (B₂<<M₂) and consider the limited case of (B₂=M₂) to be a special case (FIG. 13).

### 4D Example

Consider a 4D arrangement of pixel data for an image of shape M=(M₀, M₁, M₂, M₃) and a patch shape B=(B₀, B₁, B₂, B₃).

This 4-th dimension typically represents the time dimension (i.e. frames of a video or live feed). m₃ may also vary widely therefore depending on the application, from “buffering” only a few live frames to storing and/or reconstructing a long video for analysis. Similarly to all of the other dimensions, we also may want to set (B₃<<M₃) such that the patch shape along the 4th dimension (B₃) is significantly smaller than the total data shape in the 4th dimension (M₃), i.e. the total number of frames available. This will allow for dictionary elements to be sparse-coded/learned which reach across multiple frames.

For live/on-demand reconstructions (discussed later), this will often be set to (B₃==1), such as to only reconstruct the current frame, however this may again be treated as a special case within the implementation.

Generally, the patch index P (p₀, p₁, p₂, p₃) has patch indices pᵢ with all possible combinations of the ranges:

$$0 \geq {p}_{i} \leq {M}_{i} - {B}_{i} + 1$$

and a linear index:

$$0 \geq index \leq {\prod }_{i = 0 : 3}^{i} ( {M}_{i} - {B}_{i} + 1 )$$

Extensions beyond 4D are entirely possible (though more challenging in current computational libraries such as Arrayfire, OpenCV etc.), and would follow the pattern described above for image shape M=(M₀, M₁, M₂ . . . Mₙ₋₁), patch shape B=(B₀, B₁, B₂ . . . Bₙ₋₁). and patch indexes P=(p₀, p₁, p₂, . . . pₙ₋₁).

### Extracting Patches in Real Time

In one example, extracting the N_{batch} data sub-regions from the N-dimensional image data, using the defined N-dimensional patch comprises extracting the N_{batch} data sub-regions from the N-dimensional image data, using the defined N-dimensional patch, in real-time, for example as described below.

### Indexing

In one example, the method comprises generating indices for the N-dimensional patch in the N-dimensional image data and selecting indices from the generated indices; and wherein extracting the N_{batch} data sub-regions from the N-dimensional image data, using the defined N-dimensional patch, comprises extracting the N_{batch} data sub-regions from the N-dimensional image data, using the defined N-dimensional patch, for the selected indices.

In this way, dictionary learning may be accelerated.

In one example, generating the indices for the N-dimensional patch in the N-dimensional image data comprises generating all possible indices for the N-dimensional patch in the N-dimensional image data. In this way, the N-dimensional image data is fully indexed for the N-dimensional patch.

### Selecting Indices

In one example, selecting the indices from the generated indices comprises programmatically selecting the indices from the generated indices. In one example, selecting the indices from the generated indices comprises arbitrarily selecting the indices from the generated indices.

In one example, selecting the indices from the generated indices comprises randomly selecting indices from the generated indices, shuffling and/or permuting the generated indices and/or patterning the generated indices.

When it comes to selecting the patch indexes for the next batch operation, a batch operating dictionary learning/sparse coding implementations may:
Generate random indexes on-the-fly (size N_{batch}).
Shuffle or permute the full list of possible patch indices in some way at the beginning (either linear or multi-dimensional) and select sequential batch indexes from sub-sets of that large list (equivalent to a non-replacing draw (repeating) of size N_{batch} from all possible indexes).
Use a predetermined/pre-calculated pattern (such as non-overlapping grids) generated from the image and patch dimensions. (N batch non-replacing draw, repeating)

In one example, selecting the indices from the generated indices comprises biasedly selecting indices from the generated indices.

For the cases of live multi-frame (i.e. video) reconstruction and/or constantly changing data sources (such as a live feed of a camera, microscope, . . . ) there is the additional opportunity to perform strategic selection of the patch indexes, such as:
Preferential selection (i.e. biased selection) of previously under-sampled locations within a “live” Reconstruction
Increased focus (i.e. biased selection) on regions of a reconstruction that appear incomplete, blurry, poorly served by the dictionary, or are selected specifically as a focus region by a user.
Automatic reduction of sampling (i.e. biased selection) in areas deemed static, or background information (such as large uniform and/or dark regions).

The index selection strategy (i.e. biased selection) may be a significant factor in the performance of dictionary learning algorithms such as BPFA, K-SVD, etc., as well as the Real-Time Reconstruction method described later.

### Extraction Method

In order to efficiently extract n_{batch} arbitrarily indexed target subregions of n-dimensional data (which may be changing in real-time), it is preferable to minimise the amount of data (memory) copied from the source (pixels contained within the input pixel data) to the destination (column vectors of the reduced Y matrix for a given batch, i.e. the current step). It is therefore preferable to determine the largest single unit of contiguous memory (consistent between both the source and destination) contained within the input data cube. For many applications, especially CPU-based mathematical libraries, data are stored in Row-Major format (FIG. 17, left) (i.e. individual rows of pixel data are stored as contiguous memory). However, for the case of most GPU-based libraries, the data are stored as Column-Major, meaning the largest unit of contiguous memory in the source are the “columns” of pixel data of length m₀, and the largest consistent unit of contiguous memory between the two are “columns” of pixel data of length b₀.

For this reason, the process of extracting a given patch/sub-region is further subdivided (indexed) by contiguous “columns” of length b₀ in the source patch each mapping to the specific rows within their corresponding global patch “column” in Y_{batch}. The problem of copying all required contiguous patch “columns” to the necessary rows within each “column” of Y_{batch} is then parallelised over the cores/processing units of the target device (e.g. GPU) to maximise the speed of extracting of all of the required pixel data to form the complete Y_{batch} matrix.

Y_{batch} now forms a reduced Y matrix, capable of serving either a dictionary learning, sparse coding or reconstruction problem without ever having to calculate or store Y. As mentioned before, the exact source pixel coordinates for each contiguous “column” are obtained via the use of the source data stride information as follows:

For an “image” of shape M=(M₀, M₁, M₂, M₃), the “pixel stride” of the data (in memory) is:

$$S = ( {s}_{0} , {s}_{1} , {s}_{2} , {s}_{3} ) = ( 1 , {M}_{0} , ( {M}_{0} \times {M}_{1} ) , ( {M}_{0} \times {M}_{1} \times {M}_{2} ) )$$

$$i . e . {s}_{i} = 1 , i = 0$$

$${s}_{i} = {\prod }_{0}^{i - 1} {M}_{i} , i > 0$$

For a given “patch” index P=(p₀, p₁, p₂, p₃), the corresponding memory pointer*/position (in a contiguous source data) src* (i.e. the linear pixel index within M) can be calculated as:

$$s r {c}^{*} = \sum ( S * P ) = ( {s}_{0} \times {p}_{0} ) + ( {s}_{1} \times {p}_{2} ) + ( {s}_{1} \times {p}_{2} ) + ( {s}_{3} \times {p}_{3} )$$

In one example, the N_{batch} data sub-regions exclude overlapping data sub-regions.

### Sparse Coding

In one example, the method comprises sparse coding the extracted N_{batch} data sub-regions and optionally, storing results of the sparse coding; and wherein providing the dictionary by dictionary learning using the extracted N_{batch} data sub-regions comprises providing the dictionary by dictionary learning using the sparse coded N_{batch} data sub-regions.

Sparse coding is the process of determining the optimal weights/encodings of the dictionary elements in D for each “column” of the input Y. This can be achieved with a whole range of algorithms from BPFA/OMP/other greedy & non-greedy methods, Markov chains, Gibbs sampling, or even the prediction of a neural network). It is also usually an essential step for most of the algorithms described.

Dictionary learning steps in algorithms such as BPFA, K-SVD typically occur after a sparse coding step, providing the source for the input encoding matrix a. Y is extracted as before.

Ŷ is the (now compressed/estimated) solution to the sparse-coding result α with the dictionary D, i.e. Ŷ=Dα.

In one example, the dictionary comprises a set of p₁ atoms. It should be understood that sparse coding is a representation learning method which aims at finding a sparse representation of the input data (also known as sparse coding) in the form of a linear combination of basic elements as well as those basic elements themselves. These elements are called atoms and they compose a dictionary. Atoms in the dictionary are not required to be orthogonal, and they may be an over-complete spanning set. This problem setup also allows the dimensionality of the signals being represented to be higher than the one of the signals being observed. These two properties lead to having seemingly redundant atoms that allow multiple representations of the same signal but also provide an improvement in sparsity and flexibility of the representation. In one example, the set of p₁ atoms includes p₁ atoms, wherein p₁ is in a range from 4 to 4096, preferably in a range from 16 to 2048, more preferably in a range from 64 to 1024, for example 128, 256 or 512.

### Timestamps

In one example, storing results of the sparse coding comprises storing respective timestamps of the sparse coding.

In many cases, for the purposes of subsequent image reconstruction, it may be very beneficial to record additional information alongside the results of sparse-coding and dictionary-learning algorithms. This could be anything, including recording real-time statistics, such as the popularity of dictionary elements, or the average reconstruction error. Most likely, however, long-term storage of the sparse coding results a will be required for any subsequent reconstruction of the current frame. This is achieved by generating (zero-initialised or other) an A matrix, i.e. the full a (weight/coefficient) matrix for all possible overlapping regions of an image, now “windowed” across up to 4-dimensions, and performing a parallel copy function (similar, and simpler) than the one used for signal extraction, copying the rows of @batch into the rows of A corresponding to the specific patch index P.

For the case of “live”/real-time/frame-by-frame reconstructions in particular, we can also record another key piece of information, the timestamp at which the result (e.g. the sparse-coding of each patch) was obtained for all indexes in the batch (in this case matching the rows of A corresponding to the batch indexes). Whenever an operation is completed, the timestamp values at the indexes of a list T of length Nₜₒₜₐₗ are updated using the system clock (or otherwise).

### Real-Time Information Decay

In the context of a “live”/real-time/frame-by-frame reconstruction, we can make use of the timestamps in T by applying a “decay” function with time. Given the timestamp now at the current time (for any given reconstruction algorithm step), the “age” of the encoded information (in units of time) for a given patch index P is determined by the time difference between the current timestamp and the last recorded timestamp for that index:

$${age}_{P} = now - {t}_{P}$$

From this “age” (for example, measured in milliseconds), we can perform any desired function, to produce a decay value for each corresponding “row” in A, such as a half-life decay function:

$$decay = {f}_{decay} ( {age}_{P} ) = {( \frac{1}{2} )}^{\frac{α g {e}_{P}}{γ}} where γ is a half - life in milliseconds$$

Or some form of exponential function:

$$decay = {e}^{β \times {age}_{P}} where β is any ( likely negative ) value$$

These examples are designed to add a “fade-out” to information recovered by all previous results of sparse-coding iterations according to how long ago the results were obtained (e.g. independently for each row in a full encoding matrix A). However f_{decay} can really be any arbitrary function to favour/select certain timestamps over others.

### Electron Microscopy Data

In one example, the N-dimensional image data comprises and/or is electron microscopy data.

### Reconstructing

The second aspect provides a method of reconstructing images from sparse N-dimensional image data, wherein N is a natural number greater than or equal to 3, the method implemented by a computer comprising a processor and a memory, the method comprising:
reconstructing an image from the sparse N-dimensional image data using a dictionary, for example wherein the dictionary is provided according to the first aspect.

It should be understood that the image is reconstructed (i.e. synthesised, generated, calculated) using the computer (i.e. in silico) rather than completely acquired, for example using an electron microscope. In one example, the image comprises and/or is an electron microscopy image of a sample and hence the image is due to the interaction of electrons with the sample, for example as defined by obtained parameters of the electron microscopy and/or attributes of the sample. Electron microscopy is known. Electron microscopy images are known, for example transmission electron microscopy images, scanning electron microscopy images and electron diffraction patterns. Typically, images such as electron microscopy images are stored in raw data formats (binary, bitmap, TIFF, MRC, etc.), other image data formats (PNG, JPEG) or in vendor-specific proprietary formats (dm3, emispec, etc.). The images may be compressed (preferably, lossless compression though lossy compression there used to reduce file size by 5% to 10% while providing sub-2 Å reconstruction) or uncompressed.

TIFF and MRC file formats may be used for high quality storage of image data. Similar to MRCs, TIFFs tend to be large in file size with 32-bit MRC and 32-bit TIFF image having similar or identical file sizes. For TIFFs, the disk space may be reduced using native compression. The most common TIFF compressions are the Lempel-Ziv-Welch algorithm, or LZW, and ZIP compression. These strategies use codecs, or table-based lookup algorithms, that aim to reduce the size of the original image. Both LZW and ZIP are lossless compression methods and so will not degrade image quality. Two commonly used photography file formats that support up to 24-bit colour are PNG (Portable Network Graphics) and JPEG (Joint Photographic Experts Group). Electron micrographs typically are in grayscale so may be better suited to 8-bit file formats, which are also used in print media. PNG is a lossless file format and can utilize LZW compression similar to TIFF images. JPEG is a lossy file format that uses discrete cosine transform (DCT) to express a finite sequence of data points in terms of a sum of cosine functions. JPEG format may be avoided for archiving since quality may be lost upon each compression during processing. JPEG has a range of compression ratios ranging from JPEG100 with the least amount of information loss (corresponding to 60% of the original file size for the frame stack and 27% for the aligned sum image) to JPEG000 with the most amount of information loss (corresponding to 0.4% of the original file size for the frame stack and 0.4% for the aligned sum image).

In one example, the image is of size [M×N] pixels, wherein 240≤M, N≤10,000,000, preferably 1,000≤M, N≤5,000,000, more preferably 2,000≤M,N≤4,000,000.

For example, high resolution electron images may have sizes from [512×512] pixels to [10,000,000×10,000,000], depending on the stability of the electron microscope.

In one example, the image is grayscale, for example 8-bit, 16-bit, 24-bit or 32-bit, preferably 8-bit.

The method is implemented by the computer comprising the processor and the memory. Generally, the method may be performed using a single processor, such as an Intel (RTM) Core i3-3227U CPU @ 1.90 GHz or better, or multiple processors and/or GPUs. Suitable computers are known.

It should be understood that the N-dimensional image data is a sparse set, wherein the total area (and/or number of pixels) of, for example, a set of S sub-images, including a first sub-image of size [a×b] pixels, is less than the area (and/or number of pixels) of the image of size [M×N] pixels. In one example, the total area (and/or number of pixels) of the set of S sub-images, including the first sub-image of size [a×b] pixels, is in a range from 0.1% to 90%, preferable in a range from 1% to 75%, more preferably in a range from 10% to 50%, most preferably in a range from 15% to 35% of the area (and/or number of pixels) of the image of size [M×N] pixels.

It should be understood that S is a natural number. In one example, the set of S sub-images includes S sub-images, wherein S≥1, preferably wherein 1≤S≤10,000, more preferably wherein 10≤S≤5,000, most preferably wherein 100≤S≤1,000. In one example, each sub-image of the set of S sub-images has a size [a×b] pixels. Preferably, the sub-images are the same size to maximise dispersion of sampling. In one example, each sub-image of the set of S sub-images has a different size. In one example, the sub-images do not mutually overlap. In one example, at least some of the sub-images mutually overlap. Preferably, the sub-images do not mutually overlap since mutual overlapping decreases the efficiency and sparsity. In one example, the sub-images are not mutually adjacent. In one example, at least some of the sub-images are mutually adjacent. Preferably, the sub-images are not mutually adjacent since mutual adjacency decreases the efficiency and sparsity.

### Forming a Current (Real-Time) Reconstruction Frame

In one example, reconstructing the image from the sparse N-dimensional image data using the dictionary comprises partially reconstructing the image from the sparse N-dimensional image data using the dictionary.

In one example, reconstructing the image from the sparse N-dimensional image data using the dictionary comprises fully reconstructing the image from the sparse N-dimensional image data using the dictionary.

In one example, reconstructing the image from the sparse N-dimensional image data using the dictionary comprises reconstructing the image from the sparse N-dimensional image data using the dictionary in real-time.

When it comes to forming a reconstruction frame (at any given time), there are multiple possible scenarios:
1. A “Full” Reconstruction with access to either a “full” Ŷ, or D and a “full” A (these are equivalent as Ŷ=DA). This is possible if the results of each a matrix have been stored into the correct rows of an A matrix at the end of each batch operation. Additionally (as the results of multiple different batches sparse coded at different times are now expected to be contained within A) we may use the timestamp/decay information discussed before to preferentially display newer information (useful for “live” reconstructions).
2. A “Partial” Reconstruction which only has access to the current batch of signals Y_{batch} and/or Ŷ_{batch} (along with generic shape information, such as patch shape B and the overall dimensions of the data M). The reconstruction of this type of data will (by definition) lead to an incomplete image, effectively displaying the live input and/or output of the current batch operation, providing the most up-to-date information without any effect (positive or negative) from the accumulation of previous results.

In the case of a “full” reconstruction, the process is analogous to performing a wrap function (in a standard computational library), the opposite of an unwrap function discussed previously. However, in all standard implementations of this method, each pixel is generated from an average of all the values in Ý that correspond to that coordinate (in effect, each signal/column of Y is treated equally). This does not allow for the inclusion of a decay function to treat different columns separately depending on the time of the result. For the case of “partial” reconstructions, there is no equivalent function within standard computational libraries, and so a completely different approach must be devised.

For this reason, a new method of fast/parallel reconstruction was designed which could achieve both scenarios—instead of transforming and averaging pixels within a Y matrix to form one complete image, the reverse is performed. That is, each pixel coordinate within the output image is indexed and parallelised over the cores/processes of a host/device (CPU/GPU), for each pixel, all possible contributing values from the input (Y, Ŷ, Ŷ_{batch}, A, α_{batch} etc.) are determined and/or calculated (e.g. in the scenario where Y has not been generated in full, but inferred from D and A) and potentially scaled by the corresponding decay factor. Once the process for all pixel coordinates within the reconstruction has terminated, the “frame” is complete.

In one example, reconstructing the image from the sparse N-dimensional image data using the dictionary comprises scaling contributing values to a pixel using a decay factor.

### Determining the Pixel Value

In one example, reconstructing the image from the sparse N-dimensional image data using the dictionary comprises determining pixel values, for example using all possible contributing values from N-dimensional image data.

In one example, reconstructing the image from the sparse N-dimensional image data using the dictionary comprises determining corresponding locations of pixel values.

For example, for each pixel (in the reconstruction), once a set of valid patch locations (indexed by P) have been determined, the corresponding pixel locations within each patch may also be determined.

The z location of given pixel at coordinate x within a patch at coordinate P can therefore be determined by the difference between P and x (in each arbitrary dimension i) using:

$${z}_{i} = {x}_{i} - {p}_{i}$$

And the linear index of z is determined similarly to the pixel indexes used to determine the column src* location:

$$\sum ( {S}_{B} * Z ) = ( {s}_{B 0} \times {z}_{0} ) + ( {s}_{B 1} \times {z}_{2} ) + ( {s}_{B 1} \times {z}_{2} ) + ( {s}_{B 3} \times {z}_{3} )$$

where S_{B} refers to the “stride” of data of shape B.
Reconstructions without a Y Matrix

In one example, reconstructing the image from the sparse N-dimensional image data using the dictionary comprises reconstructing the image from the sparse N-dimensional image data using the dictionary without a Y matrix.

In many cases (such as dictionary learning), it may be necessary to calculate some form of a Ŷ matrix (such as Ŷ_{batch}), usually needed to calculate an error metric:

$${R}_{batch} = {Y}_{batch} - {\hat{Y}}_{b a t c h}$$

In these cases, the simplest approach to reconstructions is to use the Ŷ_{batch} matrix in the manner described above. However, there are situations (such as reconstructing an image from a pre-learned dictionary without performing any dictionary learning step) which will never require a full expansion of Ŷ, meaning that the time and memory cost of a reconstruction function may be reduced by continuing to avoid its creation. As previously mentioned, Ŷ_{batch} may be calculated from D and α_{batch}, traditionally via the matrix multiplication of the two. A reconstruction performed without access to a Y matrix must therefore perform this matrix multiplication for the specific “row” of A relating to the patch in question. This can be achieved by stepping through each value (indexed k=0 . . . K) within the corresponding row of A, if the value (encoding/weight) is non-zero (i.e. activated), then multiply by the pixel value in the “column” of D indexed by k and the “row” indexed by zₗᵢₙₑₐᵣ for the given parallel process. The summation of each of these coefficients and pixel values from D is equivalent to the (theoretical) pixel value in the Ŷ matrix at the position (Pₗᵢₙₑₐᵣ, zₗᵢₙₑₐᵣ).

Once the pixel value (for a given P, x and z) in (real or theoretical) Y matrix has been determined, it may then be multiplied by the decay ratio, and combined (summed) with each of the other proposed pixels from the sparse coding of all other patches which contain the pixel at the position x (each with different z coordinates), this provides the final value for the given pixel in the reconstruction.

In other words, reconstructing the image may comprise reconstructing a value for each pixel in the image (i.e. the pixel value in the Y matrix) by combining pixel values for the pixel in each of the N_{batch} data sub-regions which contain the pixel. Determining a pixel value for the pixel in each of the N_{batch} data sub-regions may comprise using a weight matrix A obtained through sparse coding, wherein the weight matrix comprises a plurality of rows wherein each row comprises encoding coefficients for one of the N_{batch} data sub-regions. Pixel factors may be obtained by multiplying each of the non-zero elements of the row of the weight matrix which corresponds to the data sub-region with an element in a corresponding column in a dictionary matrix D of the dictionary; and summing the obtained pixel factors to determine each pixel value. That is, the pixel factors may be understood as corresponding to the contribution of each data sub-region to the (final) pixel value. The element in a corresponding column in the dictionary matrix may have a column index corresponding to the index of the non-zero element in the corresponding row of the weight matrix and a row index corresponding to the location of a pixel within the data sub-region.

The method may comprise for each pixel, determining a location for each of the N_{batch} data sub-regions in the image, for example indexed by P as described above. The method may also comprise determining a location for the pixel in each of the N_{batch} data sub-regions, for example finding the z location of given pixel at coordinate x.

### Correcting for Pixel Contributions

In one example, reconstructing the image from the sparse N-dimensional image data using the dictionary comprises correcting for pixel contributions.

As the pixel values proposed by each patch containing a given pixel are combined (summed) together, a reconstructed frame must also be corrected for the variance in the count of these contributions across the image. While most pixels (away from the edges of the image in each dimension) will have the same number (|B|) contributions, the leading and trailing edge effects mean that pixels within bᵢ pixels of any edge in the i^{th} dimension will have a reduced count. In 2-dimensions, this would look as shown in FIG. 28 for the given image and patch shapes, with the integer values at each coordinate determining the number of contributions (i.e. the number of valid patch indexes P for patches that contain the given pixel).

This contribution matrix can be calculated via only the use of M and B, and so (in the case of full reconstructions), this correction step may be applied after the reconstruction is complete (removing artifacts arising from the lower contribution at the edges of the image). However, in the case of a “partial” or “live” reconstruction, it is not assumed that all possible patches have contributed to the value returned for each pixel, therefore this contribution matrix must be calculated during the reconstruction process. This can be achieved (without ever actually generating the full contribution matrix separately) by adding a step to the parallelised pixel-by-pixel reconstruction method-after the summation is complete (of all proposed pixel values at different P locations, and potentially their corresponding decay value), the total is divided (“averaged”) by the total count of valid patch locations that were determined (and were present in the source, i.e. the (real or theoretical) Y or Ŷ_{batch}).

### Similarity

In one example, the method comprises calculating a Structural Similarity Index (SSIM), a Peak Signal-to-Noise Ratio (PSNR) and/or a mean squared error (MSE) of the image calculated with respect to a fully sampled image.

In one example, a Structural Similarity Index (SSIM) of the image calculated with respect to the fully sampled image is in a range from 0.01% to 60%, preferably in a range from 0.05% to 50%, more preferably in a range from 0.1% to 20%, most preferably in a range from 0.5% to 10%. Generally, the SSIM is a perceptual metric that quantifies the perceptual difference between two similar images, as described herein in more detail, and thus the perceptual difference between the reconstructed image and the image used for training the dictionary is relatively large. That is, these images are perceptually different.

In one example, a Peak Signal-to-Noise Ratio (PSNR) of the image calculated with respect to the fully sampled image is at most 60%, preferably at most 50%, more preferably at most 20%, most preferably at most 10%. In one example, a Peak Signal-to-Noise Ratio (PSNR) of the image calculated with respect to the fully sampled image is in a range from 0.01% to 60%, preferably in a range from 0.05% to 50%, more preferably in a range from 0.1% to 20%, most preferably in a range from 0.5% to 10%. PSNR estimates absolute error, as described herein in more detail, and thus the absolute error between the reconstructed image and the image used for training the first pre-learned dictionary is relatively large. That is, these images are perceptually different.

In one example, a mean squared error (MSE) of the reconstructed image calculated with respect to the fully sampled image is at most 60%, preferably at most 50%, more preferably at most 20%, most preferably at most 10%. In one example, a mean squared error (MSE) of the image calculated with respect to the fully sampled image is in a range from 0.01% to 60%, preferably in a range from 0.05% to 50%, more preferably in a range from 0.1% to 20%, most preferably in a range from 0.5% to 10%. MSE estimates absolute error, as described herein in more detail, and thus the absolute error between the reconstructed image and the image used for training the dictionary is relatively large. That is, these images are perceptually different.

In one example, the method comprises transforming one or more atoms of the set of p₁ atoms included in the dictionary. In one example, transforming comprises and/or is rotating, resizing, translating and/or applying a transformation matrix to the set of p₁ atoms included in the first pre-learned dictionary.

### Reconstructing the Image

In one example, reconstructing the image comprises reconstructing the image according to a target property and/or a respective threshold thereof.

In one example, the target property of the image is a Structural Similarity Index (SSIM) and the respective threshold thereof is at least 60%, preferably at least 70%, more preferably at least 80%, most preferably at least 90%. Generally, the SSIM is a perceptual metric that quantifies the perceptual difference between two similar images, for example image quality degradation caused by processing such as data compression or by losses in data transmission. As applied to the method according to the second aspect, the perceptual difference results from approximation of the reconstruction, according to the obtained respective thresholds of the one or more target properties of the reconstructed image. The SSIM is a full reference metric that requires two images from the same image capture: a reference image and a processed image. As applied to the method according to the first aspect, the reference image is thus an ideal or quasi-ideal reconstructed image, computed according to the target properties of the reconstructed image (i.e. exact, without permissible thresholds) or an acquired image while the processed image is the reconstructed image computed according to the obtained respective thresholds of the one or more target properties of the reconstructed image. It should be understood that a reference image is not provided for each reconstructed image; rather, reference images are provided for representative reconstructed images and the computing thereof to achieve the respective thresholds of the one or more target properties applied to computing of other reconstructed images. In other words, the required computing so as to achieve the respective thresholds of the one or more target properties is learned.

In one example, the target property of the reconstructed electron microscopy image is a Peak Signal-to-Noise Ratio (PSNR) and the respective threshold thereof is at least 15 dB, preferably at least 20 dB more preferably at least 25 dB, most preferably at least 30 dB. PSNR estimates absolute error. PSNR estimates absolute error. PSNR is usually expressed as a logarithmic quantity using the decibel scale. PSNR is commonly used to measure the quality of reconstruction of lossy compression codecs (e.g., for image compression).

In one example, the target property of the reconstructed electron microscopy image is a mean squared error (MSE) and the respective threshold thereof is at most 0.4, preferably at most 0.3, more preferably at most 0.2, most preferably at most 0.1. MSE estimates absolute error. MSE estimates absolute error. As MSE is derived from the square of Euclidean distance, the MSE is always a positive value with the error decreasing as the error approaches zero. MSE may be used either to assess a quality of a predictor (i.e. a function mapping arbitrary inputs to a sample of values of some random variable), or of an estimator (i.e. a mathematical function mapping a sample of data to an estimate of a parameter of the population from which the data is sampled).

PSNR and MSE both estimate absolute errors. In contrast, SSIM accounts for the strong interdependencies between pixels, especially closely-spaced pixels. These inter-dependencies carry important information about the structure of the objects in the image. For example, luminance masking is a phenomenon whereby image distortions tend to be less visible in bright regions, while contrast masking is a phenomenon whereby distortions become less visible where there is significant activity or “texture” in the image. Hence, SSIM is preferred.

Resolution and sensitivity/contrast were previously standard STEM image quality metrics but are subjective, being dependent on where measured. Hence, PSNR, MSE and SSIM are preferred. Other quality metrics, including those not requiring a reference, are under development and may be applied mutatis mutandis.

In one example, the method comprises selecting a subset of p′₁ atoms from the set of p₁ atoms included in the dictionary; and
wherein reconstructing the image comprises reconstructing the image from the sparse N-dimensional image data using, for example only using, the sparse N-dimensional image data and the selected subset of p′₁ atoms included in the dictionary.

In this way, the method according to the first aspect provides a method of adaptive dictionary element selection, in which undesired atoms are pruned (i.e. removed) from the dictionary, thereby increasing an efficiency of reconstructing the image while not adversely affecting a quality thereof.

In one example, selecting the subset of p′₁ atoms from the set of p₁ atoms included in the first dictionary comprises selecting the subset of p′₁ atoms from the set of p₁ atoms included in the dictionary based on residual energies of the respective atoms of the set of p₁ atoms, for example wherein respective atoms of the subset of p′₁ atoms have respective energies of at most or of at least a threshold residual energy.

In this way, the subset of p′₁ atoms are selected from the set of p₁ atoms based on the residual energies of the respective atoms of the set of p₁ atoms, for example to reduce and/or minimise affecting a quality of the reconstructed image.

### Inpainting

In one example, reconstructing the image from the sparse N-dimensional image data using the dictionary comprises inpainting. For example, an inpainting algorithm may be used to fill in gaps in the sub-sampled data, with missing information inferred from the sub-sampled data through a combination of a dictionary learning algorithm and a sparsity pursuit algorithm. A common class of inpainting algorithms involve sparse dictionary learning. Dictionary learning algorithms produce a dictionary of basic signal patterns, which is learned from the data, which is able to via a sparse linear combination with a set of corresponding weights. This dictionary is then used in conjunction with a sparse pursuit algorithm to inpaint the pixels of each overlapping patch which when combined form a full image.

When using these techniques, the “dictionary of elements” represents a 2-dimensional matrix D for which each column represents a single, vectorised (1D) dictionary element (also referred to as an “atom”). However, the dictionary is typically used to represent data sub-regions of much higher dimensions, as shown in Table 1.

TABLE 1
Examples of higher-dimensional EM data types/multi-frame
targets and their corresponding dimensionality.

| Example Signal | Shape | Dimensionality |
|---|---|---|
| Spectral Information | 1-Dimensional | |
| Greyscale Image | 2-Dimensional | Height × Width |
| RGB Image (FIG. 3) | 3-Dimensional | Height × Width × Channels |
| Greyscale Video | 3-Dimensional | Height × Width × Frames |
| e.g. (multi-frame) STEM | | |
| BF/ABF/ADF/HAADF data | | |
| RGB Video | 4-Dimensional | Height × Width × |
| e.g. (multi-frame) | | Channels × Frames |
| combinatorial acquisition/ | | |
| colourised data | | |
| Hyperspectral Video | 4-Dimensional | Height × Width × |
| e.g. (multi-frame) | | Spectrum × Frames |
| EDS/EELS data | | |
| Series of Diffraction | 4-Dimensional | x × y × Height × Width |
| Patterns | | |
| e.g. 4D- | | |
| STEM/Ptychography, | | |
| EBSD data | | |

In the cases of higher dimensions, a method of vectorisation may be used to convert the higher-dimensional data into a vector, such that it may form the column of a dictionary of elements. In the simplest case (as shown below) the higher-dimensional data may be reshaped into a column—however any such method (e.g. tensor decomposition) to form a 1-dimensional representation of higher-dimensional data would suffice.

### Controlling an Electron Microscope

The third aspect provides a method of controlling an electron microscope, the method implemented, at least in part, by a computer comprising a processor and a memory, the method comprising:
providing parameters of the electron microscopy;
obtaining first sparse N-dimensional electron microscopy data of a sample, wherein N is a natural number greater than or equal to 3; and
reconstructing a first electron microscopy image of the sample from the first sparse N-dimensional electron microscopy data, according to the second aspect.

In this way, the reconstructed image of the first sample is used to adapt, for example optimise, the parameters of the electron microscopy in silico before subsequently acquiring the image of the second sample using the electron microscope. In this way, a duty cycle of the electron microscope and/or a quality of the acquired image may be enhanced while damage to the sample reduced.

In one example, the method comprises:
comparing the first electron microscopy image against thresholds of one or more target properties of the first electron microscopy image;
adapting the parameters of the electron microscopy based on a result of the comparing; and
obtaining second sparse N-dimensional electron microscopy data of the sample, using the adapted parameters.

In one example, the method comprises comparing the first electron microscopy image against the thresholds of one or more target properties of the first electron microscopy image, for example for validation thereof. Validation mitigates aberrations and/or artefacts due to the electron microscopy, for example due to incorrect parameters of the electron microscopy, operational errors and/or peculiarities of the sample. Optionally, based on a result of the comparing, the parameters of the electron microscope are adapted and the second acquired image of the sample is acquired, using the adapted parameters. That is, the parameters of the electron microscope are optimised or refined for the sample. In this way a quality of the second acquired image may be further enhanced while damage to the sample controlled.

In one example, adapting the parameters of the electron microscopy based on a result of the comparing comprises:
adapting, for example iteratively, recursively and/or repeatedly, the parameters of the electron microscopy, attributes of the sample and/or respective thresholds of the one or more target properties of the first electron microscopy image; and
reconstructing the first electron microscopy image of size [M×N] pixels of the first sample using the updated parameters of the electron microscopy and/or the adapted attributes of the first sample, according to the updated respective thresholds of the one or more target properties of the simulated electron microscopy image.

In this way, the second electron microscopy image is optimised since the parameters of the electron microscopy, the attributes of the sample and/or the respective thresholds of the one or more target properties of the electron microscopy image are updated, for example iteratively, recursively and/or repeatedly, so as to improve the quality of the second electron microscopy image within the respective thresholds of the one or more target properties and/or within a computer resource budget, as described previously.

It should be understood that the acquired image of the sample is a measured image, for example acquired using a detector of the electron microscope.

In one example, the method comprises:
reconstructing a second electron microscopy image of the sample from the second sparse N-dimensional electron microscopy data, according to the second aspect.

### Parameters of Electron Microscopy

The method comprises obtaining parameters (also known as settings or acquisition parameters) of the electron microscopy. In this way, the simulated electron microscopy image is computed to correspond with an acquired electron microscopy image of the sample. In one example, the parameters include: accelerating voltage, circle aberration coefficient Cs (which determines beam size), ADF detector or equivalent. Other parameters are known. In one example, the parameters additionally and/or alternatively include: condenser lens parameter (for example source spread function, defocus spread function and/or zero defocus reference) and/or objective lens parameters (for example source spread function, defocus spread function and/or zero defocus reference). It should be understood that particular electron microscopes implement particular parameters, subsets and/or combinations thereof.

### Attributes of Sample

Generally, the attributes are and/or represent physical and/or chemical characteristics of the sample. In one example, the attributes include chemical composition, structure, crystallography, lattice parameters, thickness, orientation with respect to electron beam and/or microstructure. Other attributes are known. For example, examples of other attributes include, but are not limited to, regional intensity maxima, edges, periodicity, regional chemical composition, or combinations thereof. For example, intensity maxima in the image data may represent peaks associated with particles, molecules, and/or atoms. Edges in the image data may represent particle boundaries, grain boundaries, crystalline dislocations, stress/strain boundaries, interfaces between different compositions/crystalline structures, and combinations thereof. Periodicity in the image data may be related to crystallinity and/or patterned objects. Computational analysis may be performed on the image data including, but are not limited to, a theoretically optimal sparsifying transform technique, an edge detection technique, a Gaussian mixture regression technique, a summary statistics technique, a measures of spatial variability technique, an entropy technique, a matrix decomposition information technique, a peak finding technique, or a combination thereof. Typically, the sample has a thickness of 1 to 20 unit cells. Generally, a patch is at least 2×2 pixels. In one example, the sample is crystalline. In one example, the sample is non-crystalline e.g. amorphous. Non-crystalline samples may be simulated mutatis mutandis.

### Computer, Computer Program, Non-Transient Computer-Readable Storage Medium

The fourth aspect provides a computer comprising a processor and a memory configured to implement a method according to any of the first aspect, the second aspect and/or the third aspect, a computer program comprising instructions which, when executed by a computer comprising a processor and a memory, cause the computer to perform a method according to any of the first aspect, the second aspect and/or the third aspect or a non-transient computer-readable storage medium comprising instructions which, when executed by a computer comprising a processor and a memory, cause the computer to perform a method according to any of the first aspect, the second aspect and/or the third aspect.

### Electron Microscope

The fifth aspect provides an electron microscope including a computer comprising a processor and a memory configured to implement a method according to any of the first aspect, the second aspect and/or the third aspect.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 shows a typical form of dictionary representation (an underdetermined linear equation system), where y represents a column matrix of target signals (image sub-regions), D represents the dictionary of elements, and a represents a matrix of coefficients (or sparse encodings for the dictionary of signals).

FIG. 2 shows the system of linear equations needed to be solved in the image inpainting process (for simplicity, the binary ‘mask’ φᵢ for the given patch i is shown as an elementwise multiplication upon xᵢ).

FIG. 3 shows a representation of RGB pixel data.

FIG. 4 shows reshaping of a 2D signal into a 1D column vector.

FIG. 5 shows reshaping of a 3D signal into a 2D column vector.

FIG. 6 shows reshaping of a 4D signal into a plurality of 2D column vectors, according to an exemplary embodiment.

FIG. 7 shows unwrap explanation from the Arrayfire Library Docs.

FIG. 8 shows a very “fat” matrix Y with all of the sub-regions possible in the convolution.

FIG. 9 schematically depicts 2D pixel data and a 2D patch, according to an exemplary embodiment.

FIG. 10 schematically depicts indexing of the 2D pixel data for the 2D patch of FIG. 8, according to an exemplary embodiment.

FIG. 11 schematically depicts 3D pixel data, according to an exemplary embodiment.

FIG. 12 schematically depicts RGB pixel data, according to an exemplary embodiment.

FIG. 13 schematically depicts indexing of the 3D pixel data of FIG. 11, according to an exemplary embodiment.

FIG. 14 schematically depicts 4D pixel data, according to an exemplary embodiment.

FIG. 15 schematically depicts indexing (first patch) of the 4D pixel data of FIG. 13, according to an exemplary embodiment. An illustration of a 4D patch of shape B=(B₀, B₁, B₂, B₃) within a 4D target data source of shape M=(M₀, M₁, M₂, M₃) where 0<Bᵢ≤Mᵢ (for each dimension i). Lower case variables m; denote the last (zero-based) index in the i^{th} dimension. Cells shown in grey signify valid patch indexes (indexed by the location of the first contained cell) for the given patch shape (shown in blue).

FIG. 16 schematically depicts indexing (last patch) of the 4D pixel data of FIG. 13, according to an exemplary embodiment.

FIG. 17a schematically depicts extracting for CPU data, according to an exemplary embodiment.

FIG. 17b schematically depicts extracting for GPU data, according to an exemplary embodiment.

FIG. 18 schematically depicts a 3D patch, according to an exemplary embodiment.

FIG. 19 schematically depicts sparse coding, according to an exemplary embodiment.

FIG. 20 schematically depicts dictionary learning, according to an exemplary embodiment.

FIG. 21 schematically depicts reconstructing a 2D image, according to an exemplary embodiment.

FIG. 22 schematically depicts reconstructing a 2D image (leading edge case), according to an exemplary embodiment.

FIG. 23 schematically depicts reconstructing a 2D image (trailing edge case), according to an exemplary embodiment.

FIG. 24 schematically depicts reconstructing a 2D image (determining pixel value), according to an exemplary embodiment.

FIG. 25 schematically depicts reconstructing a 2D image (determining pixel value), according to an exemplary embodiment.

FIG. 26 schematically depicts reconstructing a 2D image, according to an exemplary embodiment.

FIG. 27 schematically depicts reconstructing without a Y matrix, according to an exemplary embodiment.

FIG. 28 schematically depicts correcting for pixel values, according to an exemplary embodiment.

FIG. 29 schematically depicts a method according to an exemplary embodiment.

FIG. 30 schematically depicts a method according to an exemplary embodiment.

FIG. 31 shows a block diagram for implementing methods according to exemplary embodiments.

### DETAILED DESCRIPTION OF THE DRAWINGS

### Dictionary Representations

A dictionary of atoms can be used to sparsely represent image patches by representing each overlapping patch as a linear combination of a small number of dictionary elements and their corresponding coefficients. This allows for efficient representation and compression of image data. The choice of dictionary atoms can be learned from the data using techniques such as dictionary learning, and the resulting sparse representations can be used for tasks such as denoising, compression, and image classification.

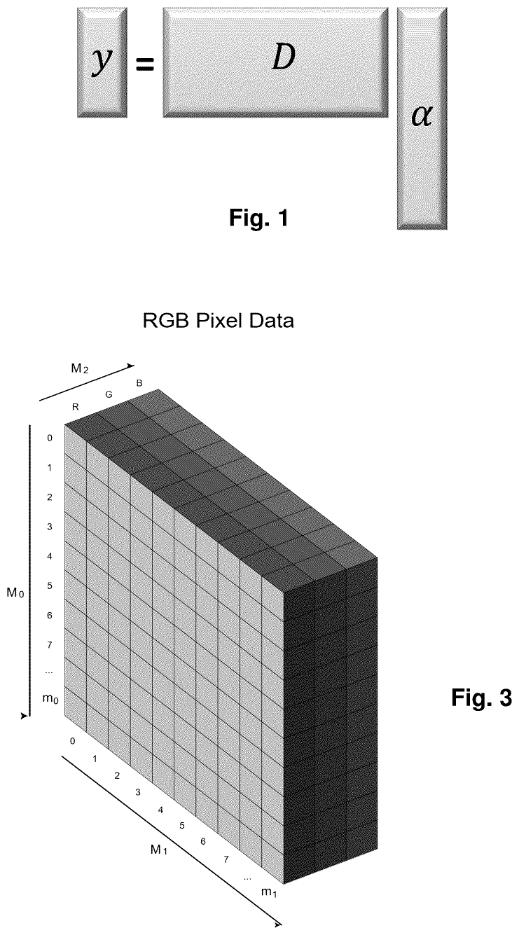

The typical form of dictionary representation (an underdetermined linear equation system) is shown in FIG. 1, where y (also termed a y matrix) represents a column matrix of target signals (image sub-regions), D represents the dictionary of elements, and a represents a matrix of coefficients (or sparse encodings for the dictionary of signals).

An example of an algorithm for dictionary-learning is BPFA (Beta-Process Factor Analysis), which can be used for subsampled image reconstruction by exploiting the sparsity of natural images in a learned dictionary of elements. Given a set of subsampled image patches, BPFA can estimate a set of latent variables that capture the underlying structure of the data, including the sparse coefficients corresponding to the dictionary elements. By leveraging a Bayesian framework, BPFA can infer the most likely set of sparse coefficients that explain the observed data, while also accounting for noise and model complexity.

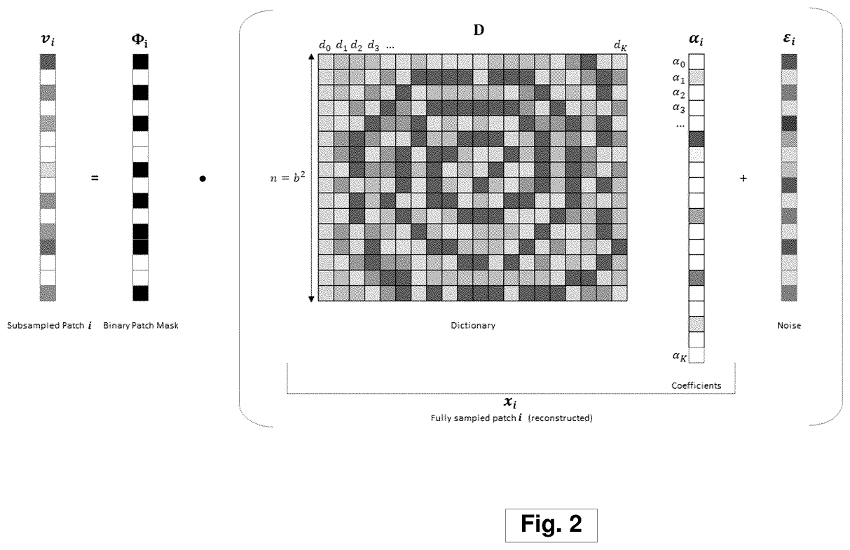

For each target signal (i.e. column of y, shown as a vector vᵢ in FIG. 2) the inpainting problem may be represented as shown in FIG. 2. The vector vᵢ may also be termed a subsampled patch i. FIG. 2 shows that the matrix D has dimensions of n=b² by K with each column of the matrix labelled d₀, d₁, . . . , d_{K}. Each column ai of the matrix a contains K coefficients labelled α₀, α₁, . . . , α_{K}. There is also a binary patch mask Φᵢ and a noise matrix εᵢ for each vector vᵢ. The matrix D multiplied by the column ai generates a fully sampled patch i which is represented by vector xᵢ.

When using these techniques, the “dictionary of elements” represents a 2-dimensional matrix D for which each column represents a single, vectorised (1D) dictionary element (also referred to as an “atom”). However, the dictionary is typically used to represent data sub-regions of much higher dimensions, as shown in Table 1.

TABLE 1
Examples of higher-dimensional EM data types/multi-frame
targets and their corresponding dimensionality.

| Example Signal | Shape | Dimensionality |
|---|---|---|
| Spectral Information | 1-Dimensional | |
| Greyscale Image | 2-Dimensional | Height × Width |
| RGB Image (FIG. 3) | 3-Dimensional | Height (M₀) × Width |
| | | (M₁) × Channels (M₂) |
| Greyscale Video | 3-Dimensional | Height × Width × Frames |
| e.g. (multi-frame) STEM | | |
| BF/ABF/ADF/HAADF data | | |
| RGB Video | 4-Dimensional | Height × Width × |
| e.g. (multi-frame) | | Channels × Frames |
| combinatorial acquisition/ | | |
| colourised data | | |
| Hyperspectral Video | 4-Dimensional | Height × Width × |
| e.g. (multi-frame) | | Spectrum × Frames |
| EDS/EELS data | | |
| Series of Diffraction | 4-Dimensional | x × y × Height × Width |
| Patterns | | |
| e.g. 4D- | | |
| STEM/Ptychography, | | |
| EBSD data | | |

In the cases of higher dimensions, a method of vectorisation may be used to convert the higher-dimensional data into a vector, such that it may form the column of a dictionary of elements. In the simplest case (as shown below) the higher-dimensional data may be reshaped into a column—however any such method (e.g. tensor decomposition) to form a 1-dimensional representation of higher-dimensional data would suffice.

### 2D Example

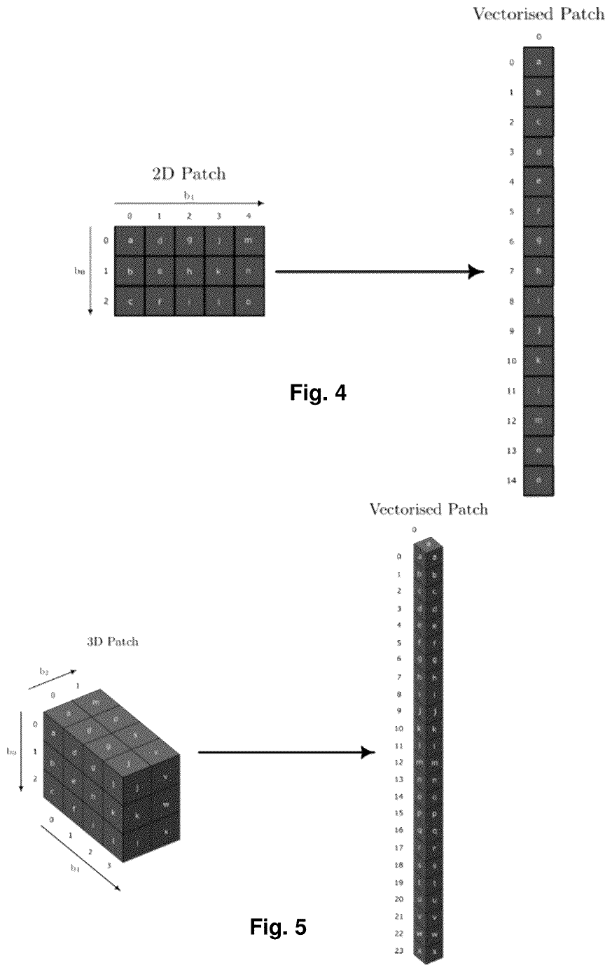

As shown in FIG. 4, any 2D signal (height b₀, width b₁ and elements (a, b, c, . . . o)) may be reshaped into a 1D column vector by appending all sequential columns (or rows). In other words, the second column of the 2D signal (d, e, f) is appended to the first column (a, b, c), the third column (g, h, i) is appended after the second column and so on for all five columns. The choice of appending column-wise in this case is for compatibility with GPU libraries, discussed later, however both approaches are valid and equivalent (given an appropriate reverse transform).

### 2D & 3D Examples

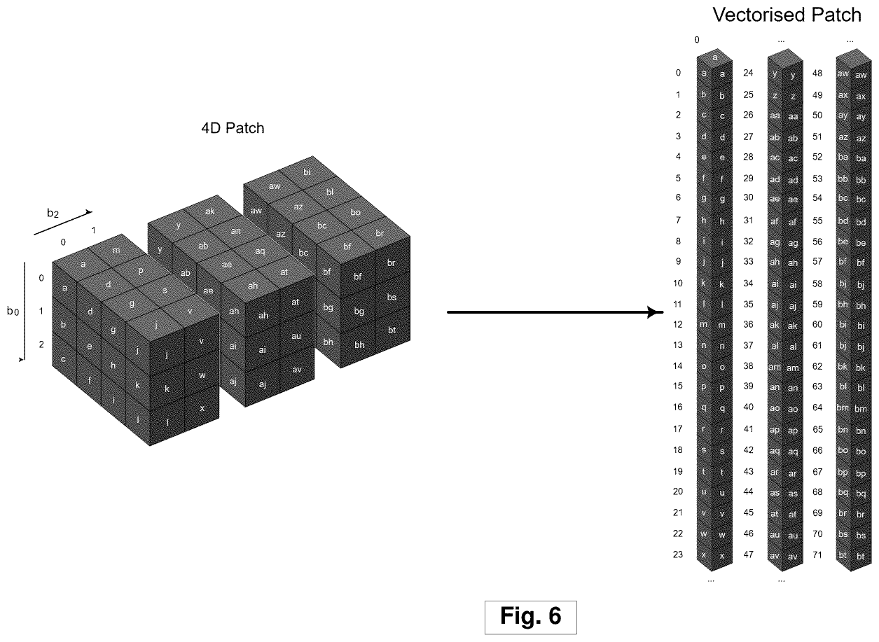

This process can be extended into 3D (FIG. 5), and 4D (FIG. 6), providing a method of transforming higher-dimensional data into a column vector (the format necessary for dictionary learning and sparse-coding) and a reverse method of returning to the higher-dimensional shape. In FIG. 5, the 3D patch has dimensions (height b₀, width b₁ and depth b₂). In this example, the height and depth are equal to two and the width is equal to four so there are elements and elements (a, b, c, . . . v, w, x). In FIG. 6, the fourth dimension is the use of multiple 3D patches and each 3D patch is similar to those shown in FIG. 5. Thus, there are 24 elements (a, b, c, . . . v, w, x) in the first patch, 24 elements (y, z, ab, . . . , at, au, av) in the second patch, and 24 elements (aw, ax, ay, . . . , br, bs, bt) in the third patch.

### Extracting Patches (4D)

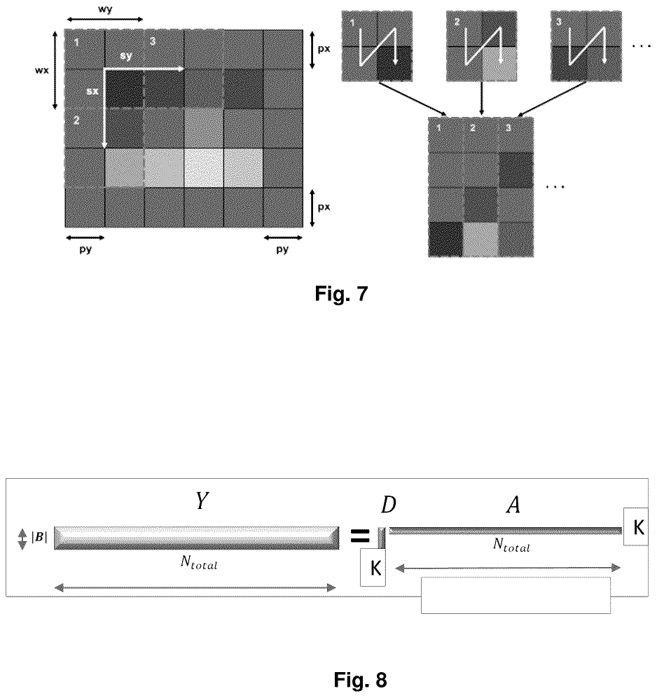

Traditionally, in order to perform methods such as dictionary learning and sparse-coding on sub-regions of an image, a process of “unwrapping” the data would be involved (FIG. 7), a method of generating the entire Y matrix with a column for each and every possible overlapping sub-region of the “image” (or perhaps some crop of it).

In the case of many libraries, such as Arrayfire (GPU Matrix Library in C++), this defaults to non-overlapping patches, but is easily changed by altering the stride value (in this case, sx and sy). The result for all of these libraries (C++, Python, Matlab etc) is essentially a very “fat” matrix Y with all of the sub-regions possible in the convolution (FIG. 8). As shown in FIG. 8, the matrix Y contains relatively small vectorised patch length |B| compared to image size although |B| is typically much larger than K. There are many (1:100 s:1000 s) thousands of patches. A represents the full weight/coefficient matrix for all possible overlapping regions of an image (using a 2D sliding window). If subsets of this full Y matrix are needed for batch operations, they are then extracted or accessed from this full Matrix stored in memory.

While the method of achieving this is a convolution, and so has many efficient implementations, it quickly becomes very costly in terms of memory usage (for large M, such as 4K+ images or hyperspectral data with a large number of channels), but also requires a significant amount of time in computation, especially if expected to be performed in real-time (such as in the case of live/frame-by-frame reconstruction of a high-framerate, evolving input (with time). In many cases, the full Y matrix is therefore not necessary to compute, such as in the intended case of dictionary learning/sparse coding algorithms like BPFA which only operate on N_{batch}<<Nₜₒₜₐₗ overlapping subregions per iteration (i.e. at a given time).

To perform dictionary learning rapidly on many (often thousands) of arbitrary (programmatically selected) sub-regions of an image, we must first index all possible patches (or sub-regions) and then determine an efficient method of signal/pixel extraction (using any given set of patch indices) from a potentially variable input source in order to form the necessary columns of the signal matrix Y for a given batch. Each column of this matrix represents a vectorised sub-region of an image to be used in the current dictionary-learning and/or sparse-coding batch/operation.

### 2D Example

In the following notation (going forward) Mᵢ, Bᵢ etc. will refer to the length of the shape in the i^{th} dimension, and mᵢ, bᵢ etc. will refer to the last zero-based index in that dimension.

$$e . g . {M}_{i} = 10 , {m}_{i} = {M}_{i} - 1 = 9$$

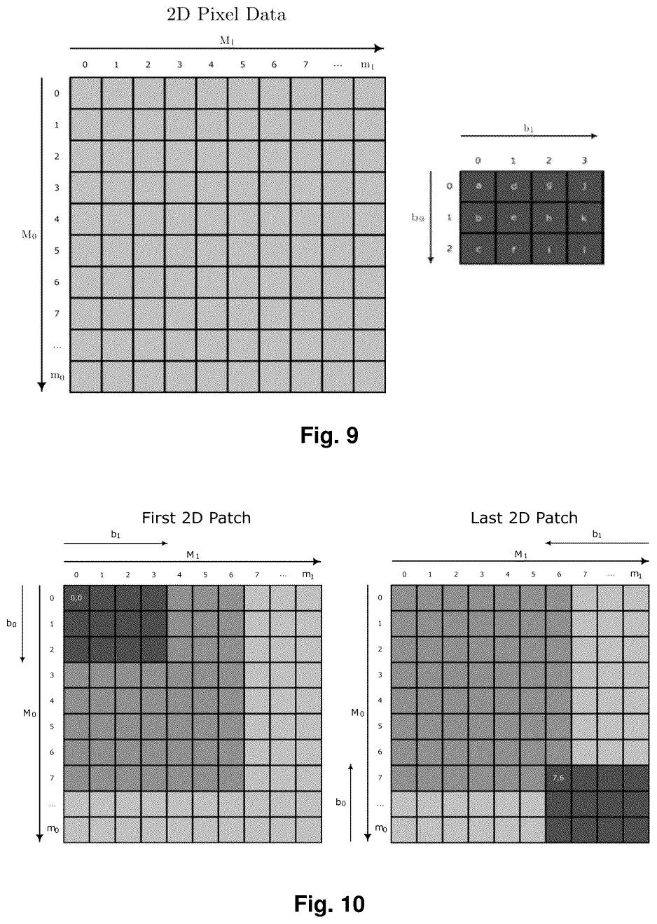

Consider the (2D) arrangement of pixel data for an image of shape M=(M₀, M₁) (FIG. 9). In this case, M=(10×10). For the patch shape (FIG. 9), B=(B₀, B₁). In this case, B=(3, 4).

There will be a total of:

$$( {M}_{0} - {B}_{0} + 1 ) \times ( {M}_{1} - {B}_{1} + 1 )$$

$$patches = ( 10 - 3 + 1 ) \times ( 10 - 4 + 1 ) = 56 patches .$$

The patches may be indexed by the (in this case 2D) coordinates of the first contained/origin pixel, or reduced further to a linear index Pₗᵢₙₑₐᵣ for indexing in system memory. All that is needed to convert between a linear index and coordinates is the total dimensions of the pixel data, and the shape of the patch/sub-region.

For patch index P (p₀, p₁), the linear index Pₗᵢₙₑₐᵣ=(M₀−B₀+1)×p₁+p₀ (ordering Column-Major) is shown in FIG. 10.

Denoting the patch index coordinates as P (p₀, p₁), indexes (in 2D) therefore range between:

$$0 \geq {p}_{0} \leq ( {M}_{0} - {B}_{0} + 1 ) and 0 \geq {p}_{1} \leq ( {M}_{1} - {B}_{1} + 1 )$$

$$0 \geq {P}_{linear} \leq ( {M}_{0} - {B}_{0} + 1 ) \times ( {M}_{1} - {B}_{1} + 1 )$$

In this case, the last possible patch index is therefore (7,6) and the corresponding linear index is [55].

This can be generalised to i dimension, where the index P of any single possible subregion will lie within the range 0≥pᵢ≤Mᵢ−Bᵢ+1. The set of all combinations of these valid indices in each of the i dimensions form the total set of possible data sub-regions. Each patch index P may also be converted to a pixel index within the full data shape M by using the known data stride of the source data “cube” in memory.

### 3D Example

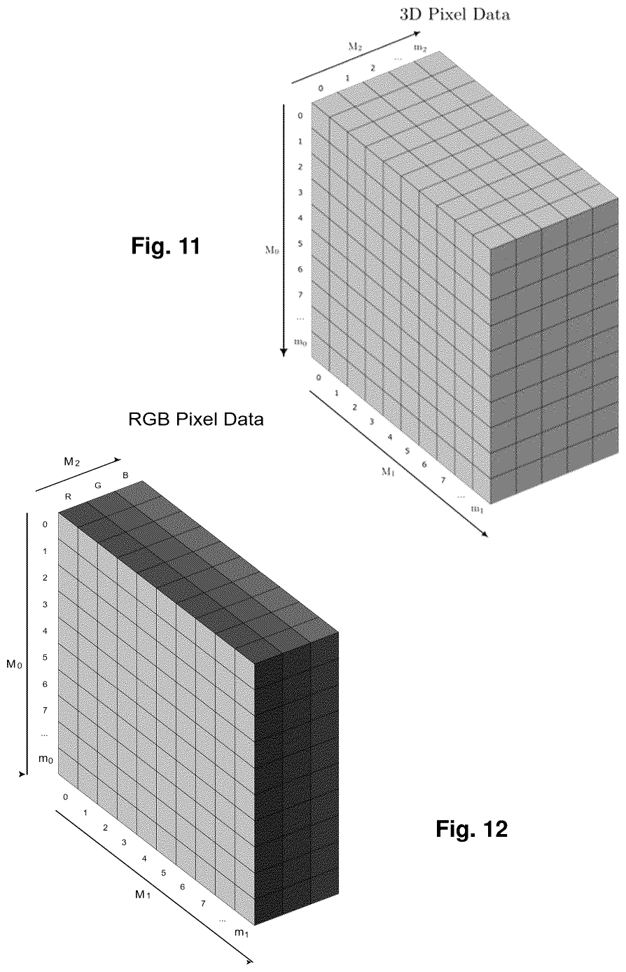

Consider the 3D arrangement of pixel data shown in FIG. 11 for an “image: of shape M=(M₀, M₁, M₂) and a patch shape B=(B₀, B₁, B₂).

The term “image” here is vague as this third dimension could take multiple forms. Perhaps most typically, m₂ can be considered the number of channels an image has, in the case of:
Greyscale Images/Video (m₂=1 channel)
RGB Images/Video (m₂=3 channels).
Hyperspectral Image/Video (m₂=n_{channels})

But this could be something else entirely, from (m₂=nᵥₐₗᵤₑₛ) different colour space conversions e.g. CMYK, or indexing of diffraction patterns in 4D-STEM.

For Greyscale, RGB Image (FIG. 12) and RGB Video, it often (though not always) makes sense to work with a dictionary with a vectorized column length equal to a patch of shape B where (B₂=M₂), i.e. use a patch shape equal to the total number of channels (such as extracting overlapping RGB patches from an image/video to work with an RGB dictionary). In most typical implementations of DL/sparse-coding, BPFA, OMP etc., this is what is performed (usually by-default due to the use of an unwrapping method (as described above) which is often limited to this behaviour.

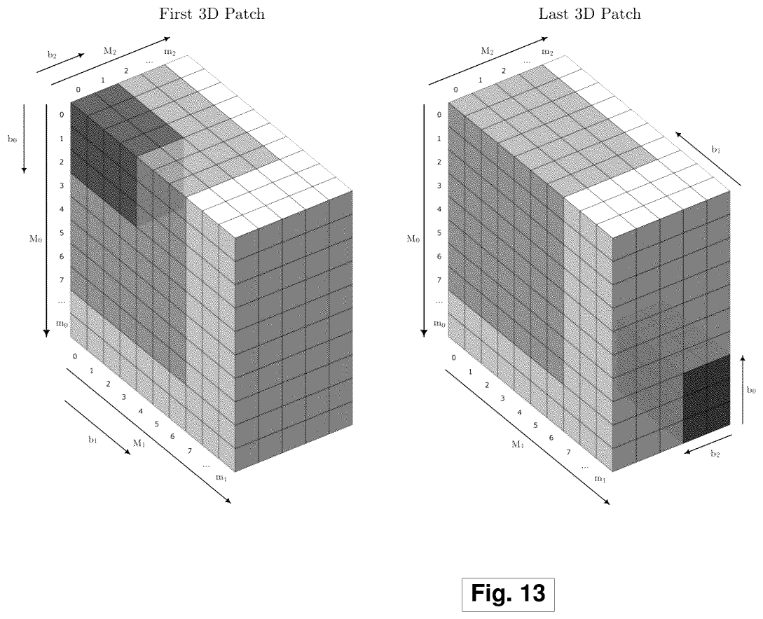

However, this will not always be the optimal case, such as for Hyperspectral Image/Video, or any of the other uses of this dimension where you will (very likely) want to capture dictionary elements significantly smaller than the total (B₂<<M₂) that traverse the channel dimension in the same way a 2D window traverses the image (as B₀<<M₀ and B₁<<M₁). This is shown in FIG. 13 which shows the first and last 3D patch with each patch having dimensions (B₀, B₁, B₂). Therefore, for generalising the implementation, we can assume (B₂<<M₂) and consider the limited case of (B₂=M₂) to be a special case.

### 4D Example

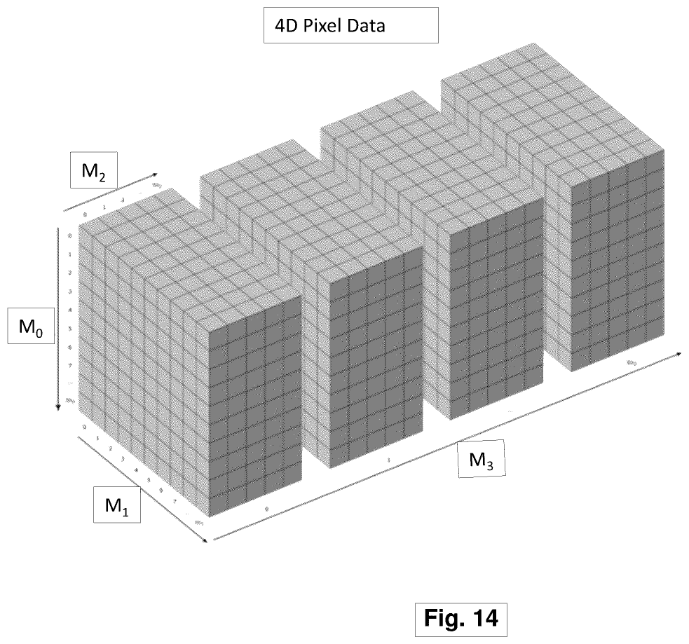

Consider the 4D arrangement of pixel data for an image of shape M=(M₀, M₁, M₂, M₃) and a patch shape B=(B₀, B₁, B₂, B₃) (FIG. 14).

This 4-th dimension typically represents the time dimension (i.e. frames of a video or live feed). m₃ may also vary widely therefore depending on the application, from “buffering” only a few live frames to storing and/or reconstructing a long video for analysis. Similarly to all of the other dimensions, we also may want to set (B₃<<M₃) such that the patch shape along the 4th dimension (B₃) is significantly smaller than the total data shape in the 4th dimension (M₃), i.e. the total number of frames available. This will allow for dictionary elements to be sparse-coded/learned which reach across multiple frames.

For live/on-demand reconstructions (discussed later), this will often be set to (B₃==1), such as to only reconstruct the current frame, however this may again be treated as a special case within the implementation.

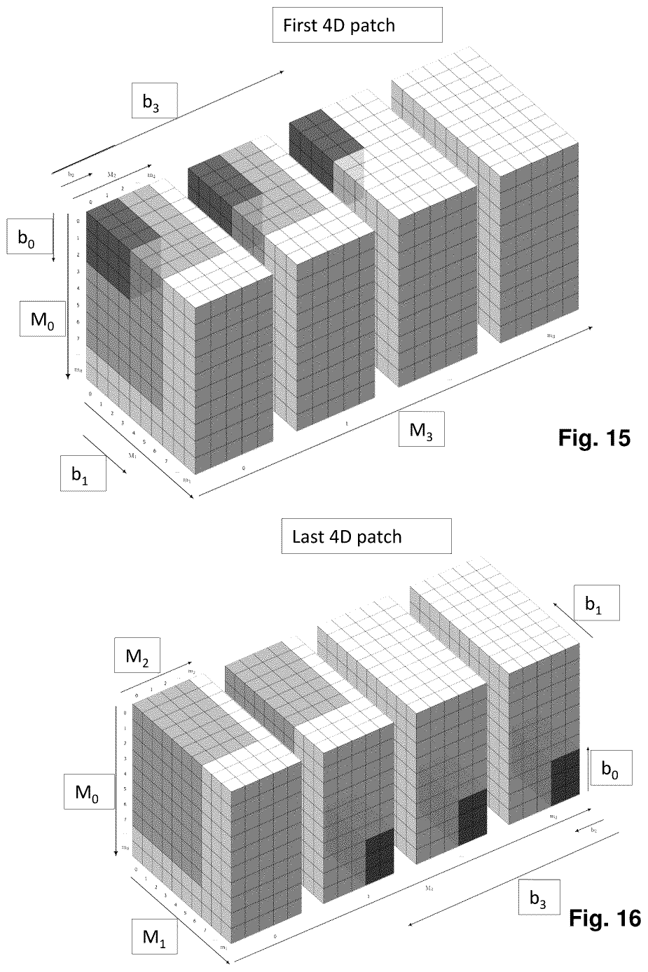

Generally, (FIG. 15 and FIG. 16) the patch index P (p₀, p₁, p₂, p₃) has patch indices pᵢ with all possible combinations of the ranges:

$$0 \geq {p}_{i} \leq {M}_{i} - {B}_{i} + 1$$

and a linear index:

$$0 \geq index \leq {\prod }_{i = 0 : 3}^{i} ( {M}_{i} - {B}_{i} + 1 )$$

Extensions beyond 4D are entirely possible (though more challenging in current computational libraries such as Arrayfire, OpenCV etc.), and would follow the pattern described above for image shape M=(M₀, M₁, M₂ . . . Mₙ₋₁), patch shape B=(B₀, B₁, B₂ . . . Bₙ₋₁). and patch indexes P=(p₀, p₁, p₂, . . . pₙ₋₁).

### Real-Time Signal Extraction

### Programmatic Patch Indexing

When it comes to selecting the patch indexes for the next batch operation, a batch operating dictionary learning/sparse coding implementations may:
Generate random indexes on-the-fly (size N_{batch}).
Shuffle or permute the full list of possible patch indices in some way at the beginning (either linear or multi-dimensional) and select sequential batch indexes from sub-sets of that large list (equivalent to a non-replacing draw (repeating) of size N batch from all possible indexes).
Use a predetermined/pre-calculated pattern (such as non-overlapping grids) generated from the image and patch dimensions. (N_{batch} non-replacing draw, repeating)

For the cases of live multi-frame (i.e. video) reconstruction and/or constantly changing data sources (such as a live feed of a camera, microscope, . . . ) there is the additional opportunity to perform strategic selection of the patch indexes, such as:
Preferential selection of previously under-sampled locations within a “live” reconstruction
Increased focus on regions of a reconstruction that appear incomplete, blurry, poorly served by the dictionary, or are selected specifically as a focus region by a user.
Automatic reduction of sampling in areas deemed static, or background information (such as large uniform and/or dark regions).

The index selection strategy is a significant factor in the performance of dictionary learning algorithms such as BPFA, K-SVD, etc., as well as the Real-Time Reconstruction method described later.

### Extraction Method

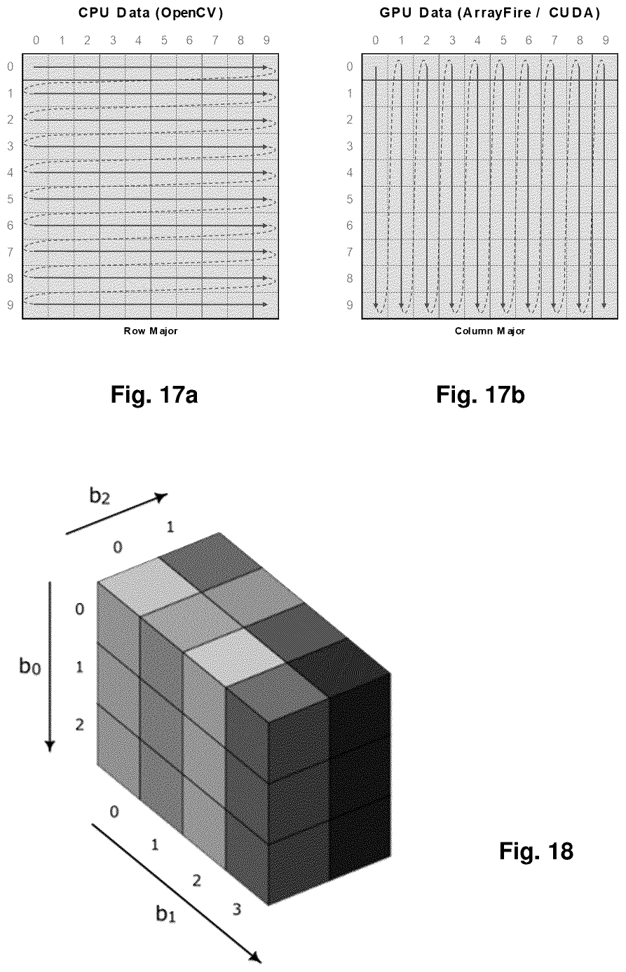

In order to efficiently extract n_{batch} arbitrarily indexed target subregions of n-dimensional data (which may be changing in real-time), it is preferable to minimise the amount of data (memory) copied from the source (pixels contained within the input pixel data) to the destination (column vectors of the reduced Y matrix for a given batch, i.e. the current step). It is therefore preferable to determine the largest single unit of contiguous memory (consistent between both the source and destination) contained within the input data cube. For many applications, especially CPU-based mathematical libraries, data are stored in Row-Major format (FIG. 17a) (i.e. individual rows of pixel data are stored as contiguous memory). However, for the case of most GPU-based libraries, the data are stored as Column-Major (FIG. 17b), meaning the largest unit of contiguous memory in the source are the “columns” of pixel data of length m₀, and the largest consistent unit of contiguous memory between the two are “columns” of pixel data of length b₀.

For this reason, the process of extracting a given patch/sub-region is further subdivided (indexed) by contiguous “columns” of length b₀ in the source patch each mapping to the specific rows within their corresponding global patch “column” in Y_{batch}. The problem of copying all required contiguous patch “columns” to the necessary rows within each “column” of Y_{batch} is then parallelised over the cores/processing units of the target device (e.g. GPU) to maximise the speed of extracting of all of the required pixel data to form the complete Y_{batch} matrix.

Y_{batch} now forms a reduced Y matrix, capable of serving either a dictionary learning, sparse coding or reconstruction problem without ever having to calculate or store Y. As mentioned before, the exact source pixel coordinates for each contiguous “column” are obtained via the use of the source data stride information as follows:

For an “image” of shape M=(M₀, M₁, M₂, M₃), the “pixel stride” of the data (in memory) is:

$$S = ( {s}_{0} , {s}_{1} , {s}_{2} , {s}_{3} ) = ( 1 , {M}_{0} , ( {M}_{0} \times {M}_{1} ) , ( {M}_{0} \times {M}_{1} \times {M}_{2} ) )$$

$$i . e . {s}_{i} = 1 , i = 0$$

$${s}_{i} = {\prod }_{0}^{i - 1} {M}_{i} , i > 0$$

For a given “patch” index P=(p₀, p₁, p₂, p₃), the corresponding memory pointer*/position (in a contiguous source data) src* (i.e. the linear pixel index within M) can be calculated as:

$$s r {c}^{*} = \sum ( S * P ) = ( {s}_{0} \times {p}_{0} ) + ( {s}_{1} \times {p}_{2} ) + ( {s}_{1} \times {p}_{2} ) + ( {s}_{3} \times {p}_{3} )$$

### 3D Example

FIG. 18 shows the case of a 3D patch of shape:

B=(b₀,b₁,b₂)=(3,4,2)

Each column (region of contiguous memory) is denoted by a different colour, representing the regions of memory that may be copied in a single memcpy call (C++/CUDA copy command). (In practice, b₀ is much larger than this diagram, and represents a much more efficient length relative to the full shape of the patch, increasingly so as the patch shape increases in the first dimension)

### Parallel Signal Extraction Logic (in Theory)

For patch index P:
For contiguous column c within the patch:
   Determine src* from P and c.
   Copy “column” of length b₀ from src* to destination rows in Y_{batch} “column” determined by P

### Parallel Signal Extraction Logic (in Practice)

For global core/processing index θ (optimised for device-specific performance):
Determine P and c from θ
Determine src* from P and c
Copy “column” of length b₀ from src* to destination rows in Y_{batch} “column” determined by P

### The Results of Batch Operations

### Sparse Coding

Sparse coding is the process of determining the optimal weights/encodings of the dictionary elements in D for each “column” of the input Y. This can be achieved with a whole range of algorithms from BPFA/OMP/other greedy & non-greedy methods, Markov chains, Gibbs sampling, or even the prediction of a neural network). It is also usually an essential step for most of the algorithms described.

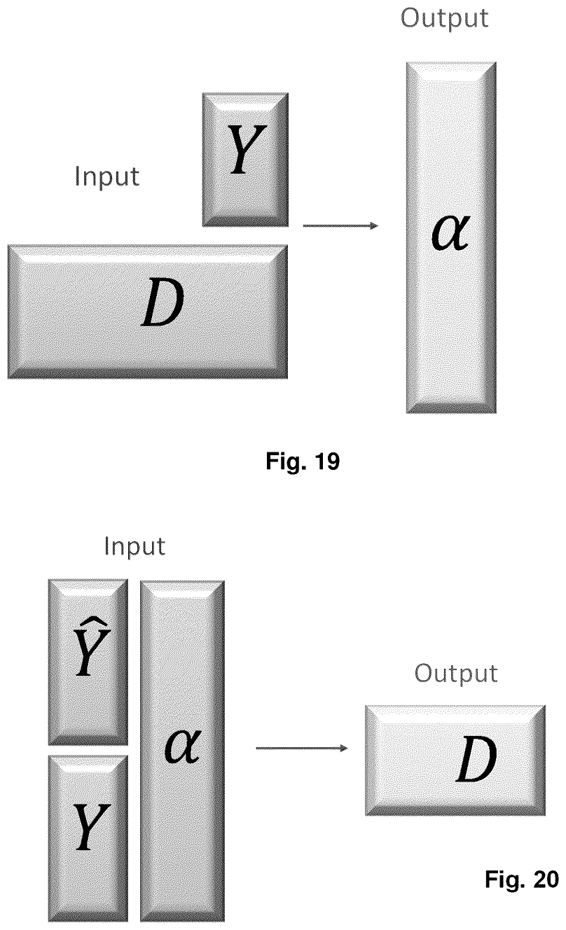

Any typical batch operation of sparse coding (FIG. 19) therefore typically takes in a Y matrix (in this case Y_{batch}) and a D matrix (dictionary), producing the approximate/optimised encoding matrix a (i.e. a batch).

### Dictionary Learning

Dictionary learning steps in algorithms such as BPFA, K-SVD typically occur after a sparse coding step, providing the source for the input encoding matrix a. Y is extracted as before.

Ŷ is the (now compressed/estimated) solution to the sparse-coding result α with the dictionary D, i.e. Ý=Da.

Any typical batch operation of dictionary learning (FIG. 20) therefore typically takes in a Y matrix, usually a Ŷ matrix, and the result of a batch of sparse coding a, and returns an improved suggestion for the dictionary matrix D.

### Storing the Results for a Time-Dependent Reconstruction

In many cases, for the purposes of subsequent image reconstruction, it may be very beneficial to record additional information alongside the results of sparse-coding and dictionary-learning algorithms. This could be anything, including recording real-time statistics, such as the popularity of dictionary elements, or the average reconstruction error. Most likely, however, long-term storage of the sparse coding results a will be required for any subsequent reconstruction of the current frame. This is achieved by generating (zero-initialised or other) an A matrix, i.e. the full a (weight/coefficient) matrix for all possible overlapping regions of an image, now “windowed” across up to 4-dimensions, and performing a parallel copy function (similar, and simpler) than the one used for signal extraction, copying the rows of α_{batch} into the rows of A corresponding to the specific patch index P.

For the case of “live”/real-time/frame-by-frame reconstructions in particular, we can also record another key piece of information, the timestamp at which the result (e.g. the sparse-coding of each patch) was obtained for all indexes in the batch (in this case matching the rows of A corresponding to the batch indexes). Whenever an operation is completed, the timestamp values at the indexes of a list T of length Nₜₒₜₐₗ are updated using the system clock (or otherwise).

### Real-Time Information Decay

In the context of a “live”/real-time/frame-by-frame reconstruction, we can make use of the timestamps in T by applying a “decay” function with time. Given the timestamp now at the current time (for any given reconstruction algorithm step), the “age” of the encoded information (in units of time) for a given patch index P is determined by the time difference between the current timestamp and the last recorded timestamp for that index:

$${age}_{P} = now - {t}_{P}$$

From this “age” (for example, measured in milliseconds), we can perform any desired function, to produce a decay value for each corresponding “row” in A, such as a half-life decay function:

$$decay = {f}_{decay} ( {age}_{P} ) = {( \frac{1}{2} )}^{\frac{{age}_{P}}{γ}} where γ is a half - life in milliseconds$$

Or some form of exponential function:

$$decay = {e}^{β \times {age}_{P}} where β is any ( likely negative ) value$$

These examples are designed to add a “fade-out” to information recovered by all previous results of sparse-coding iterations according to how long ago the results were obtained (e.g. independently for each row in a full encoding matrix A). However f_{decay} can really be any arbitrary function to favour/select certain timestamps over others.

### Forming the Current (Real-Time) Reconstruction Frame

When it comes to forming a reconstruction frame (at any given time), there are multiple possible scenarios:
1. A “Full” Reconstruction with access to either a “full” Ŷ, or D and a “full” A (these are equivalent as Ŷ=DA). This is possible if the results of each a matrix have been stored into the correct rows of an A matrix at the end of each batch operation. Additionally (as the results of multiple different batches sparse coded at different times are now expected to be contained within A) we may use the timestamp/decay information discussed before to preferentially display newer information (useful for “live” reconstructions).
2. A “Partial” Reconstruction which only has access to the current batch of signals Y_{batch} and/or Ŷ_{batch} (along with generic shape information, such as patch shape B and the overall dimensions of the data M). The reconstruction of this type of data will (by definition) lead to an incomplete image, effectively displaying the live input and/or output of the current batch operation, providing the most up-to-date information without any effect (positive or negative) from the accumulation of previous results.

In the case of a “full” reconstruction, the process is analogous to performing a wrap function (in a standard computational library), the opposite of an unwrap function discussed previously. However, in all standard implementations of this method, each pixel is generated from an average of all the values in Ý that correspond to that coordinate (in effect, each signal/column of Y is treated equally). This does not allow for the inclusion of a decay function to treat different columns separately depending on the time of the result. For the case of “partial” reconstructions, there is no equivalent function within standard computational libraries, and so a completely different approach must be devised.

For this reason, a new method of fast/parallel reconstruction was designed which could achieve both scenarios—instead of transforming and averaging pixels within a Y matrix to form one complete image, the reverse is performed. That is, each pixel coordinate within the output image is indexed and parallelised over the cores/processes of a host/device (CPU/GPU), for each pixel, all possible contributing values from the input (Y, Ŷ, Ŷ_{batch}, A, α_{batch} etc.) are determined and/or calculated (e.g. in the scenario where Y has not been generated in full, but inferred from D and A) and potentially scaled by the corresponding decay factor. Once the process for all pixel coordinates within the reconstruction has terminated, the “frame” is complete.

### 2D Example

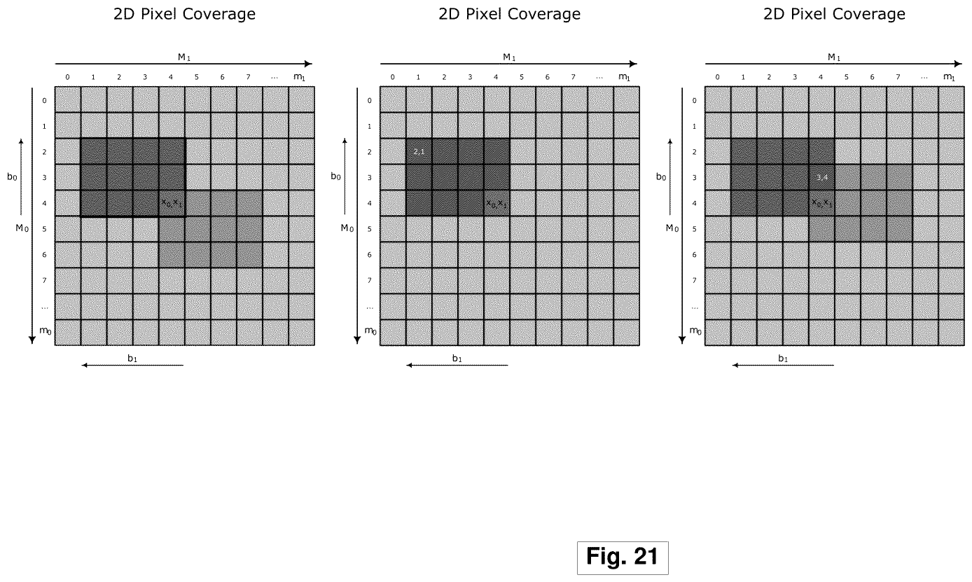

Consider the following example (FIG. 21) in 2-dimensions for an image of shape M (M₀, M₁)=(10, 10) and a patch shape B (B₀, B₁)=(3,4). Available to the reconstruction algorithm (in this example) is a “full” Ŷ matrix, containing the sparse coding results for every possible B₀×B₁ window of the data indexed by the (top left) starting pixel location P=(p₀, p₁).

Selecting the pixel coordinate x=(x₀, x₁)=(4,4) to reconstruct, we see that the theoretical set of P (patch) indexes that contain the pixel are in the range:

$${x}_{0} - {b}_{0} \leq {p}_{0} \leq {x}_{0} \qquad 4 - 2 ( = 2 ) \leq {p}_{0} \leq 4$$

$${x}_{1} - {b}_{1} \leq {p}_{1} \leq {x}_{1} \qquad 4 - 3 ( = 1 ) \leq {p}_{0} \leq 4$$

i.e. this set would be P(2,1): P(4,4):
{P(2,1), P(3,1), P(4,1), P(2,2), P(3,2), P(4,2), P(2,3), P(3,3), P(4,3), P(2,4), P(3,4), P(4,4)}

### Edge Cases

The above is an example for a typical pixel (within the “middle” of the image), however there are of-course edge-cases where not all of these coordinates will be valid.

### Leading Edge Case

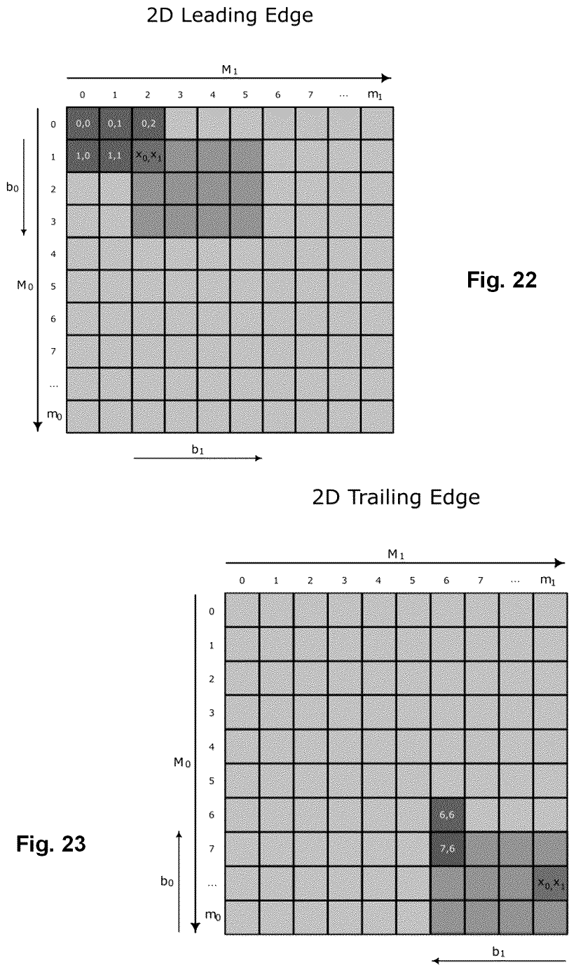

For the case of a pixel coordinate x within bᵢ of the leading edge (for each of the dimensions i), such as (in the above example) x=(x₀, x₁)=(1,2), certain patch indexes P that would lie outside of the data cube (i.e. pᵢ<0) are not possible (FIG. 22).

For each dimension, we therefore place a limit on the set of possible indexes, with a minimum value of 0.

$$max ( 0 , {x}_{i} - {b}_{i} ) \leq {p}_{i}$$

### Trailing Edge Case

Similarly, for the case of a pixel coordinate x within bᵢ on the trailing edge (for each of the dimensions i), such as (in the above example) x=(x₀, x₁)=(8,10), certain patch indexes P that would lie outside of the data cube (i.e. pᵢ>mᵢ−bᵢ) are also not possible (FIG. 23).

For each dimension, we therefore place another limit on the set of possible indexes, with a maximum value of mᵢ−bᵢ.

$${p}_{i} \leq min ( {x}_{i} , {m}_{i} - {b}_{i} )$$

Therefore, for the reconstruction of any given pixel at coordinate x, the set of all possible patch indexes P is determined by all possible combinations of (zero-based) integers for each dimension i in the range(s):

$$max ( 0 , {x}_{i} - {b}_{i} ) \leq {p}_{i} \leq min ( {x}_{i} , {m}_{i} - {b}_{i} )$$

### Determining the Pixel Value

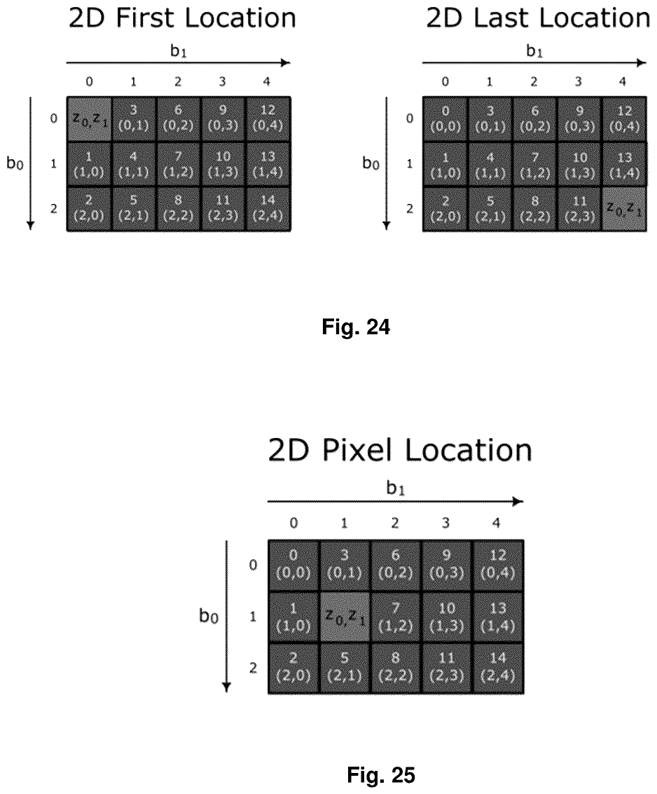

For each pixel (in the reconstruction), once the set of valid patch locations (indexed by P) have been determined, the corresponding pixel locations within each patch must also be determined. Consider the following case (FIG. 24, a 2D example) of a pixel at coordinate x=(x₀, X₁), contained within a valid patch at location P=(p₀, p₁). Each possible patch coordinate P corresponds to a patch with the given pixel (at x) in a different location z=(z₀, z₁) within the 2-dimensional patch/window.

For a patch location P=(p₀, p₁)=x=(x₀, x₁), this corresponds to a patch with the given pixel in the first coordinate z=(0,0) or linear index 0. The last possible z location (inside the patch) corresponds to a patch located at P=(p₀,p₁)=(x₀−b₀, x₁−b₁) where z=(b₀, b₁)=(2,4) and a linear index (in this 2D case) of B₀×B₁=14.

The z location of given pixel at coordinate x within a patch at coordinate P can therefore be determined (FIG. 25) by the difference between P and x (in each arbitrary dimension i) using:

$${z}_{i} = {x}_{i} - {p}_{i}$$

And the linear index of z is determined similarly to the pixel indexes used to determine the column src* location:

$$\sum ( {S}_{B} * Z ) = ( {s}_{B 0} \times {z}_{0} ) + ( {s}_{B 1} \times {z}_{2} ) + ( {s}_{B 1} \times {z}_{2} ) + ( {s}_{B 3} \times {z}_{3} )$$

where S_{B} refers to the “stride” of data of shape B

### Full Example

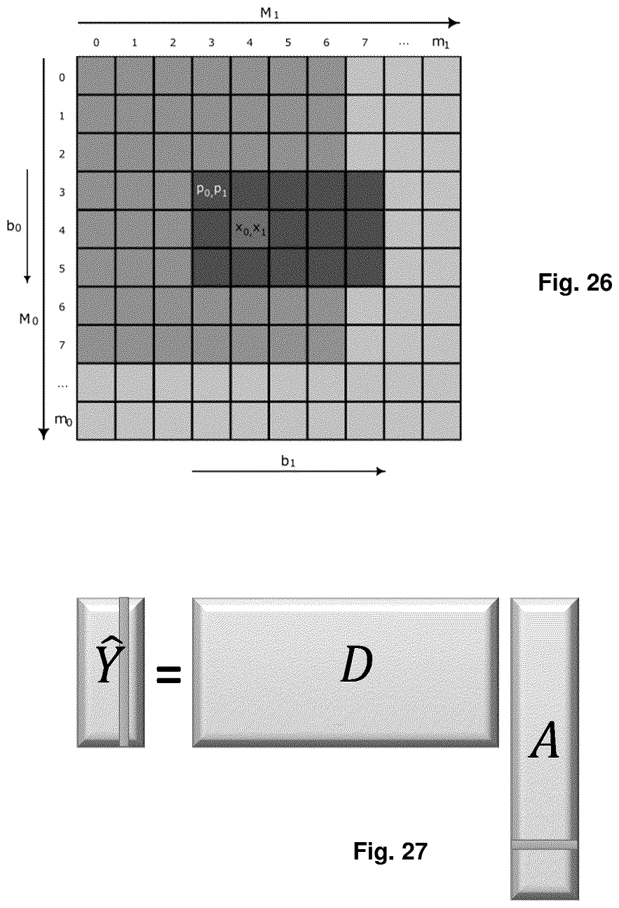

For the example shown in FIG. 26:

$$Image Shape \qquad M = ( {M}_{0} \times {M}_{1} ) = ( 10 \times 10 )$$

$$Patch Shape \qquad B = ( {B}_{0} \times {B}_{1} ) = ( 3 \times 5 )$$

$$Pixel Coord \qquad x = ( {x}_{0} , {x}_{1} ) = ( 4 , 4 ) [ 44 ]$$

$$Patch Coord \qquad P = ( {p}_{0} , {p}_{1} ) = ( 3 , 3 ) [ 33 ]$$

The z coordinate is calculated as z=x−b . . .

$$z = ( {z}_{0} , {z}_{1} ) = ( {x}_{0} - {b}_{0} , {x}_{1} - {b}_{1} ) = ( 4 - 3 , 4 - 3 ) = ( 1 , 1 )$$

With a linear index of . . .

$${z}_{linear} = \sum ( {S}_{B} * Z ) = ( {s}_{B 0} \times {z}_{0} ) + ( {s}_{B 1} \times {z}_{2} ) = ( 1 \times 1 ) + ( 3 \times 1 ) = 4$$

Thus, the suggested pixel value, calculated for the patch at coordinate P, for the pixel at coordinate x (at the location z within the patch) can be found at the (real or theoretical) Ŷ matrix in the Pₗᵢₙₑₐᵣ=55^{th} “column” and the zₗᵢₙₑₐᵣ=4^{th} “row”. Using the known patch shape B, we can determine that the “column” length of Ŷ is equal to |B|=(B₀×B₁×B₂×B₃), and therefore obtain the position (in memory) of that pixel as:

$${src}^{*} = {P}_{linear} \times \vert B \vert + {z}_{linear} = 55 \times 15 + 4 = {829}^{th} pixel within \hat{Y}$$

If working with a (reduced) Ŷ_{batch}, Pₗᵢₙₑₐᵣ in the above equation must be replaced with the linear (batch) index of the patch corresponding to the coordinate P within the set of N batch indexes defining the batch.

Reconstructions without a Y Matrix

In many cases (such as dictionary learning), it may be necessary to calculate some form of a Ŷ matrix (such as Y_{batch}), usually needed to calculate an error metric (FIG. 27):

$${R}_{batch} = {Y}_{batch} - {\hat{Y}}_{batch}$$

In these cases, the simplest approach to reconstructions is to use the Y_{batch} matrix in the manner described above. However, there are situations (such as reconstructing an image from a pre-learned dictionary without performing any dictionary learning step) which will never require a full expansion of Y, meaning that the time and memory cost of a reconstruction function may be reduced by continuing to avoid its creation. As previously mentioned, Y_{batch} may be calculated from D and @batch, traditionally via the matrix multiplication of the two. A reconstruction performed without access to a Y matrix must therefore perform this matrix multiplication for the specific “row” of A relating to the patch in question. This can be achieved by stepping through each value (indexed k=0 . . . K) within the corresponding row of A, if the value (encoding/weight) is non-zero (i.e. activated), then multiply by the pixel value in the “column” of D indexed by k and the “row” indexed by zₗᵢₙₑₐᵣ for the given parallel process. The summation of each of these coefficients and pixel values from D is equivalent to the (theoretical) pixel value in the Y matrix at the position (Pₗᵢₙₑₐᵣ, zₗᵢₙₑₐᵣ).

Once the pixel value (for a given P, x and z) in (real or theoretical) Y matrix has been determined, it may then be multiplied by the decay ratio, and combined (summed) with each of the other proposed pixels from the sparse coding of all other patches which contain the pixel at the position x (each with different z coordinates), this provides the final value for the given pixel in the reconstruction.

### Correcting for Pixel Contributions

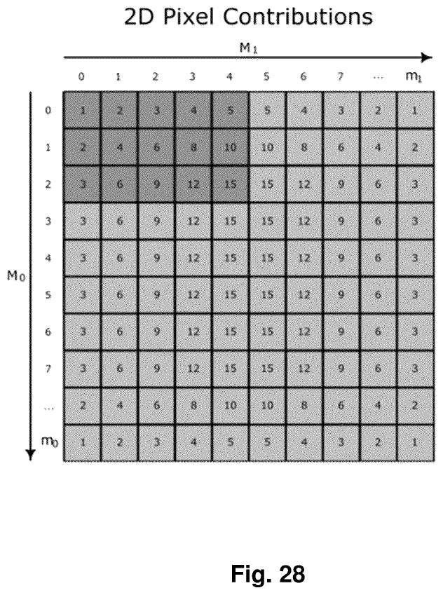

As the pixel values proposed by each patch containing a given pixel are combined (summed) together, a reconstructed frame must also be corrected for the variance in the count of these contributions across the image. While most pixels (away from the edges of the image in each dimension) will have the same number (|B|) contributions, the leading and trailing edge effects mean that pixels within bᵢ pixels of any edge in the i^{th} dimension will have a reduced count. In 2-dimensions, this would look as shown in FIG. 28 for the given image and patch shapes, with the integer values at each coordinate determining the number of contributions (i.e. the number of valid patch indexes P for patches that contain the given pixel).

This contribution matrix can be calculated via only the use of M and B, and so (in the case of full reconstructions), this correction step may be applied after the reconstruction is complete (removing artifacts arising from the lower contribution at the edges of the image). However, in the case of a “partial” or “live” reconstruction, it is not assumed that all possible patches have contributed to the value returned for each pixel, therefore this contribution matrix must be calculated during the reconstruction process. This can be achieved (without ever actually generating the full contribution matrix separately) by adding a step to the parallelised pixel-by-pixel reconstruction method-after the summation is complete (of all proposed pixel values at different P locations, and potentially their corresponding decay value), the total is divided (“averaged”) by the total count of valid patch locations that were determined (and were present in the source, i.e. the (real or theoretical) Y or Y_{batch}).

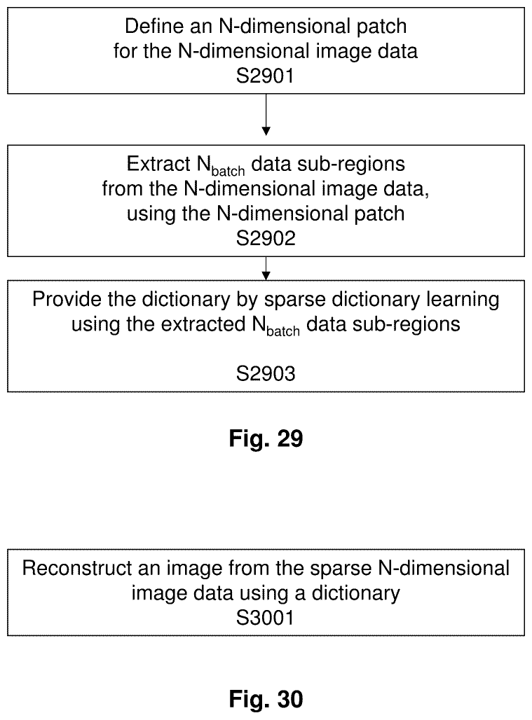

FIG. 29 schematically depicts a method according to an exemplary embodiment.

The method is of providing a dictionary by sparse dictionary learning of N-dimensional image data, wherein N is a natural number greater than or equal to 3, the method implemented by a computer comprising a processor and a memory, the method comprising:
defining an N-dimensional patch for the N-dimensional image data (S2901);
extracting N_{batch} data sub-regions from the N-dimensional image data, using the defined N-dimensional patch (S2902); and
providing the dictionary by sparse dictionary learning using the extracted N_{batch} data sub-regions (S2903).

The method may include any of the steps described with respect to the first aspect.

FIG. 30 schematically depicts a method according to an exemplary embodiment.

The method is of reconstructing images from sparse N-dimensional image data, wherein N is a natural number greater than or equal to 3, the method implemented by a computer comprising a processor and a memory, the method comprising:
reconstructing an image from the sparse N-dimensional image data using a dictionary, for example wherein the dictionary is provided according to the first aspect (S3001).

The method may include any of the steps described with respect to the first aspect and/or the second aspect.

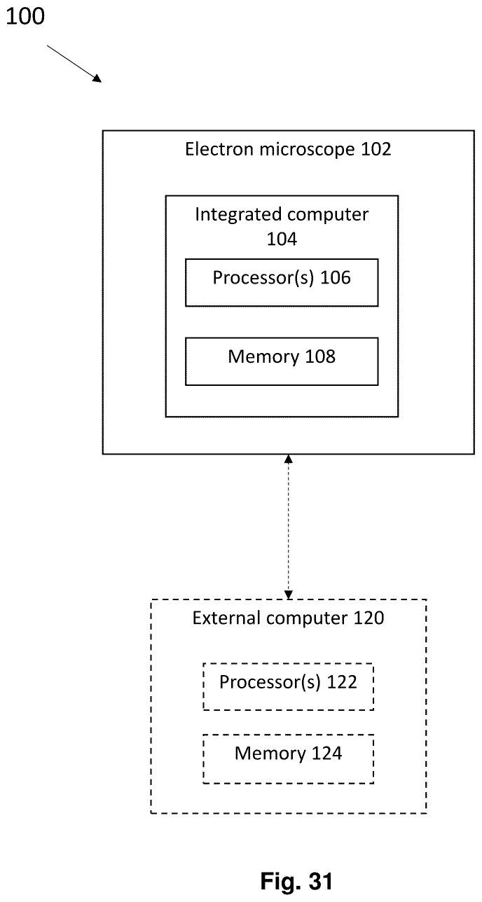

FIG. 31 is a block diagram of a system for implementing any of the methods described with respect to the first, second and/or third aspects. The system comprises an electron microscope 102 comprising an integrated computer 104. The computer 104 comprises a processor 106 and memory 108. The computer 104 may be configured to implement a method according to any of the first, second and/or third aspects above. Specifically, the processor 106 may be configured to provide a dictionary by sparse dictionary learning, reconstruct images from sparse N-dimensional image data and/or to control an electron microscope in accordance with the methods described above.

The system may further comprise an external computer 120 comprising a processor 122 and memory 124. The external computer 120 is arranged externally to the electron microscope 102. That is, the external computer 120 is not integrated within the electron microscope 102 itself. The external computer 120 may communicate with the electron microscope via any suitable communication channel, such as via a wired connection or via a wireless connection. The system 100 may be alternatively configured such that the external computer 120 is configured to implement a method according to any of the first, second and/or third aspects above, instead of the computer 104. In other words, the electron microscope 102 may transmit image data (including N-dimensional image data, sparse N-dimensional image data) to the external computer 120 via the communication channel, such that the external computer 120 is able to carry out the aforementioned methods, rather than the integrated computer 104.

### Glossary of Terms

ABF: Annular Bright-Field. A method of imaging samples in STEM using bright-field detectors in which an image formed using a ring-shaped detector by low-angled forward scattered electrons, not including the most central part of the transmitted beam.
CS-STEM: Compressive-Sensing (driven) Scanning Transmission Electron Microscopy. The acquisition and subsequent reconstruction of a full image of a given sample using only subsampled measurements.
DCT: Discrete Cosine Transform. A transform of a signal or image from the spatial domain to the frequency domain using sinusoidal functions (in this context, discretised into a set of dictionary elements)
HAADF: High-Angle Annular Dark-Field. A method of imaging samples in STEM by collecting scattered electrons with an annular dark-field detector lying outside of the path of the transmitted electron beam.
K-SVD: Dictionary Learning algorithm performing generalised K-Means clustering via Singular Value Decomposition (alternating between a sparse coding step and updating individual dictionary atoms to better fit the data).
I₀ Norm: The count of the total number of non-zero elements of a given vector.

$${‖ e ‖}_{0} = {\sum }_{i} ( {\vert {e}_{i} \vert}^{0} )$$

I₁ Norm: The sum of the magnitudes of all elements in a given vector.

$${‖ e ‖}_{1} = {\sum }_{i} ( {\vert {e}_{i} \vert}^{1} )$$

MOD: Method of Optimal Directions. One of the first sparse dictionary learning algorithms developed in, alternating between a sparse coding step and updating the dictionary via matrix pseudo-inverse calculations
OMP: Orthogonal Matching Pursuit.
PSNR: Peak-Signal-to-Noise-Ratio. An image quality metric measuring the ratio between the maximal power of a signal and the power of corrupting noise, as measured against a reference image.
SSIM: Structural Similarity Index. An image quality metric measuring the visible structural similarity (between two images).

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of providing a dictionary by sparse dictionary learning of N-dimensional image data, wherein N is a natural number greater than or equal to 3, the method implemented by a computer comprising a processor and a memory, the method comprising:
defining an N-dimensional patch for the N-dimensional image data;
extracting N_{batch} data sub-regions from the N-dimensional image data, using the defined N-dimensional patch; and
providing the dictionary by dictionary learning using the extracted N_{batch} data sub-regions.

2. The method according to claim 1, comprising generating indices for the N-dimensional patch in the N-dimensional image data and selecting indices from the generated indices; and
wherein extracting the N_{batch} data sub-regions from the N-dimensional image data, using the defined N-dimensional patch, comprises extracting the N_{batch} data sub-regions from the N-dimensional image data, using the defined N-dimensional patch, for the selected indices.

3. The method according to claim 2, wherein selecting the indices from the generated indices comprises randomly selecting indices from the generated indices, shuffling and/or permuting the generated indices and/or patterning the generated indices.

4. The method according to claim 2, wherein selecting the indices from the generated indices comprises biasedly selecting indices from the generated indices.

5. The method according to claim 1, wherein the N_{batch} data sub-regions exclude overlapping data sub-regions.

6. The method according to claim 1, comprising sparse coding the extracted N_{batch} data sub-regions and optionally, storing results of the sparse coding; and
wherein providing the dictionary by dictionary learning using the extracted N_{batch} data sub-regions comprises providing the dictionary by dictionary learning using the sparse coded N_{batch} data sub-regions.

7. The method according to claim 6, wherein storing results of the sparse coding comprises storing respective timestamps of the sparse coding.

8. The method according to claim 1, wherein extracting the N_{batch} data sub-regions from the N-dimensional image data, using the defined N-dimensional patch comprises extracting the N_{batch} data sub-regions from the N-dimensional image data, using the defined N-dimensional patch, in real-time.

9. The method according to claim 1, wherein the N-dimensional image data comprises and/or is electron microscopy data.

10. A method of reconstructing images from sparse N-dimensional image data, wherein N is a natural number greater than or equal to 3, the method implemented by a computer comprising a processor and a memory, the method comprising:
reconstructing an image from the sparse N-dimensional image data using a dictionary.

11. The method according to claim 10 wherein reconstructing the image comprises reconstructing a value for each pixel in the image by combining pixel values for the pixel in each of the N_{batch} data sub-regions which contain the pixel.

12. The method according to claim 11, further comprising, for each pixel in the image,
determining a location for each of the N_{batch} data sub-regions in the image, and
determining a location for the pixel in each of the N_{batch} data sub-regions.

13. The method according to claim 12 comprising determining a pixel value for the pixel in each of the N_{batch} data sub-regions using a weight matrix obtained through sparse coding, wherein the weight matrix comprises a plurality of rows wherein each row comprises encoding coefficients for one of the N_{batch} data sub-regions.

14. The method according to claim 13 comprising determining a pixel value for the pixel in each of the N_{batch} data sub-regions by
obtaining pixel factors by multiplying each of the non-zero elements of the row of the weight matrix which corresponds to the data sub-region with an element in a corresponding column in a dictionary matrix of the dictionary; and
summing the obtained pixel factors to determine each pixel value.

15. The method according to claim 14 wherein the element in a corresponding column in the dictionary matrix has a column index corresponding to the index of the non-zero element in the corresponding row of the weight matrix and a row index corresponding to the location of a pixel within the data sub-region.

16. A method of controlling an electron microscope, the method implemented, at least in part, by a computer comprising a processor and a memory, the method comprising:
providing parameters of the electron microscopy;
obtaining first sparse N-dimensional electron microscopy data of a sample, wherein N is a natural number greater than or equal to 3; and
reconstructing a first electron microscopy image of the sample from the first sparse N-dimensional electron microscopy data, by using a dictionary.

17. The method according to claim 16, comprising:
comparing the first electron microscopy image against thresholds of one or more target properties of the first electron microscopy image;
adapting the parameters of the electron microscopy based on a result of the comparing; and
obtaining second sparse N-dimensional electron microscopy data of the sample, using the adapted parameters.

18. The method according to claim 17, comprising:
reconstructing a second electron microscopy image of the sample from the second sparse N-dimensional electron microscopy data, according to claim 10.

19. (canceled)

20. (canceled)
